(19) United States
(12) Patent Application Publication
(10) Pub. No.: US 2011/0012535 A1
(43) Pub. Date: Jan. 20, 2011

(54) PORTABLE LIGHTING DEVICES

(75) Inventors: Stacey West, Ontario, CA (US); Anthony Maglica, Ontario, CA (US)

Correspondence Address: JONES DAY, 555 SOUTH FLOWER STREET FIFTIETH FLOOR, LOS ANGELES, CA, 90071, US

(73) Assignee: Mag Instrument, Inc.

(21) Appl. No.: 12/505,555

(22) Filed: Jul. 20, 2009

Related U.S. Application Data
(63) Continuation-in-part of application No. 12/502,237, filed on Jul. 14, 2009.

(51) Int. Cl. H05B 41/36; F21L 4/00

(52) U.S. Cl. 315/307; 315/291; 362/157

(57) ABSTRACT

A portable lighting device and method of operating the portable lighting device are disclosed. The portable lighting device is configured to operate using a portable source of power having a plurality of modes of operation. The portable lighting device comprises a main power circuit including a light source, an inertial sensor having a plurality of signal outputs, and a controller electrically connected to the outputs of the inertial sensor and the main power circuit in a manner to permit the controller to enter into a new mode of operation based on signals received from the outputs of the inertial sensor. One method of operating the portable lighting device is by positioning the portable lighting device to one of a plurality of predetermined positions to enter into one of a plurality of modes of operation. Each of the plurality of predetermined positions is associated with one of the plurality of modes of operation.

This application is a continuation-in-part of U.S. patent application Ser. No. 12/502,237, filed on Jul. 14, 2009, now pending, which is incorporated herein by reference.

### TECHNICAL FIELD

The current inventions generally relate to the field of portable lighting devices, including for example, flashlights, lanterns and headlamps, and their circuitry.

### BACKGROUND

Various hand held or portable lighting devices, including flashlights, are known in the art. Such lighting devices typically include one or more dry cell batteries having positive and negative electrodes. The batteries are arranged electrically in series or parallel in a battery compartment or housing. The battery compartment contains the batteries and may also, in some instances, be used to hold the lighting device. An electrical circuit is established from a battery electrode or terminal through conductive means which are electrically coupled with a light source, such as a lamp bulb or a light emitting diode (“LED”). After passing through the light source, the electric circuit continues through conductive means that are electrically coupled to the light source, which in turn are in electrical contact with the other electrode or terminal of a battery. The circuit includes a switch to open or close the circuit. Actuation of the switch to close the electrical circuit enables current to pass through the lamp bulb, LED, or other light source—and through the filament, in the case of an incandescent lamp bulb—thereby generating light.

It may be desirable to provide multiple modes of operation for different needs. For example, in addition to the normal “full power” or “standard power” mode, a power reduction mode, blink mode and/or an SOS mode can be implemented in a portable lighting device, such as a flashlight. In such a portable lighting device, the user elects the desired mode of operation by manipulation of a user interface, which can be a main switch. For example, when the portable lighting device is in the normal mode or the power save mode of operation, the portable lighting device may be transitioned to another mode of operation, such as an SOS mode, by manipulating the main switch to momentarily turn “off” and then turn back “on” the portable lighting device. In another lighting device, the main switch may be required to be depressed and held a certain period of time to cause the lighting device to index to the next operational mode. A portable lighting device that includes advanced functionality may also include an electronic power switch controlled by a microcontroller or microprocessor to provide the desired functionality.

One potential problem of a portable lighting device with multiple functions described above is that a user needs to manipulate the main switch in some manner in order to enter into a new mode of operation. If the main switch is located on the barrel of, for example, a flashlight, the sequence of pushing and releasing the main switch could cause the flashlight under operation to point away from the area of intended illumination.

Another problem associated with the use of a main switch as the user interface to enter a new mode of operation is that the required manipulation sequence can be complicated or simply take too long to index through the different modes of operation. Yet another problem associated with the main switch approach is that the frequent manipulation of the main switch to index through the different modes of operation could cause the mechanical parts of the switch to prematurely wear out, shortening the useful life of the portable lighting device.

Accordingly, a need exists for a portable lighting device with an improved user interface that does not require the repeated or complicated manipulation of a mechanical switch to index through the various modes of operation that the portable lighting device may provide.

Flashlights and other portable lighting devices have conventionally employed a mechanical power switch in the main power circuit of the flashlight to turn “on” and turn “off” the portable lighting device. When the user turns “on” the portable lighting device, the user typically presses down or otherwise manipulates the mechanical power switch to mechanically connect two contacts to close the switch and complete the power circuit, thereby allowing current to flow from the positive terminal of the batteries, through the light source and to the negative terminal of the batteries. When the user turns “off” the portable lighting device, the user again manipulates the mechanical switch to disconnect the two contacts of the switch and thereby open the switch and break the power circuit. The mechanical power circuit in such devices, therefore, acts as a conductor in completing the power circuit, and thus conducts current throughout the operation of the portable lighting device.

Because mechanical power switches form part of the circuit of the lighting device, the contacts of such switches tend to be fairly heavy duty. Accordingly, such switches tend to require a certain degree of force and time in order to close and open their contacts. As a result, using a portable lighting device having a mechanical power switch as a signaling device over a prolonged period may be difficult. For example, the force required to manipulate the switch between the “on” and “off” positions may fatigue the user after a prolonged period of using the portable lighting device in a signaling application. Further, with some mechanical power switches, it may simply take too much time to close and open the mechanical power switch in order to turn “on” and “off” the portable lighting device to perform certain signaling applications.

Another problem with using the portable lighting device's main switch to implement a user implemented signaling mode is that the repeated manipulation of the main switch to turn “off” and then turn back “on” the lighting device may cause the mechanical parts of the switch to prematurely wear out, shortening the life of the lighting device.

Some switches employed in portable electronic lighting devices may require less force to manipulate if they do not form part of the main power circuit of the lighting device and are thus not as heavy duty. While this is potentially beneficial from a user fatigue standpoint in a signaling application, multi-mode portable electronic devices present their own set of problems for user implemented signaling modes.

For example, in multi-mode electronic portable lighting devices, the various modes of operation may be selected by a user turning off the lighting device for less than a predetermined period of time, such as 1 to 2 seconds, and then turning the lighting device back on again. In response to this short turn off period, the lighting device indexes to the next mode.

It would therefore be difficult to use a multi-mode portable electronic lighting device configured in this manner for a user implemented signaling mode. This is because the user must wait more than the predetermined period of time before turning the lighting device back on, otherwise it will automatically index to the next mode of operation, thereby interfering with the user's intended signaling operation. In other words, the user would be precluded from signaling with short alternating periods of light and no light to communicate through, for example, Morse code.

Accordingly, a need exists for an improved portable electronic lighting device that may be used in a user implemented signaling mode without the manipulation of a mechanical switch to repeatedly turn the lighting device “on” and “off.”

Night lights that plug into the wall are conventionally known. These night lights are not portable, however, thus making a night light required in multiple rooms to provide adequate safety. Some individuals use flashlights or other portable lighting devices as an alternative or in addition to the conventional wall plug-in nightlights. However, if a conventional flashlight or portable lighting device is left on over night to provide constant light, the batteries of the lighting device are quickly drained.

Alternatively, if the portable lighting device is turned off to save battery power, locating the lighting device in the dark can be problematic. In some situations it could even lead to injury, particularly in emergency situations, as the user searches for the portable lighting device.

Accordingly, a need exists for a portable lighting device that has improved functionality as a night light.

In multi-mode portable electronic lighting devices, the electronics of the lighting device may include a number of preprogrammed functions. Such modes may include a “standard power” mode, power reduction mode, a blink mode and an SOS mode. However, the various individual modes cannot be adjusted. As a result, the user of a portable lighting device must simply select the particular mode of operation that best fits his or her needs.

One approach to solving this problem is to program additional modes of operation into the lighting device. For example, instead of having a single power reduction mode, the portable lighting device may be provided with two discrete power reduction modes, such as a 75% power reduction mode and a 50% power reduction mode. This discrete approach to the problem is not very practical, however, because as each new mode of operation is added to the portable lighting device, more time is required to index through the different discrete modes of operation, thus making it less likely that a user will even use the advanced functionality of the lighting device. A single switch, also does not provide a practical option for including a number of modes of operation. Indeed, for some designs, it would be cumbersome to attempt to access over, for example, four or five discrete modes of operation.

Accordingly, a need exists for a multi-mode portable lighting device that enables user adjustable modes of operation.

### SUMMARY

One object of the present patent document is to provide an improved portable lighting device that addresses or at least ameliorates one or more of the foregoing problems or needs. To this end, a number of portable lighting devices and methods of operating same are described herein. In general, the portable lighting devices may be any type of portable lighting device, including, for example, flashlights, headlamps, lanterns, etc.

In one aspect, a lighting device is provided comprising a housing including a portable source of power, a light source connected to the portable source of power, electronic components for providing multiple modes of operation of the lighting device, and a sensor sensing an orientation of the housing which effects one of the multiple modes of operation.

In another aspect, a portable lighting device is provided comprising a housing including a portable source of power, such as one or more batteries, a light source connected to said one or more batteries, electronic components configured to provide multiple modes of operation of the lighting device, and a sensor for sensing an orientation of the lighting device. The electronics are configured to select a mode of operation based on the orientation of the lighting device at the time it is turned on. Preferably, the lighting device comprises one or more icons for use in determining the orientation of the lighting device when the lighting device is turned on.

In yet a further aspect, a multi-mode portable electronic lighting device is provided comprising a controller configured to implement a plurality of modes of operation, and a user interface for inputting commands to the controller. The user interface comprises a motion sensitive user interface in which commands are input through predefined positions or movements of the portable electronic lighting device. In one embodiment, the user interface comprises an inertial sensor electronically coupled to the controller. In another embodiment, the inertial sensor may comprise an accelerometer. The controller may, for example, be configured to receive mode selection commands from the user interface for selecting between different modes of operation by the controller. Alternatively, the controller may be configured to receive adjustment commands for adjusting one or more modes of operation. In still a further implementation, the controller may be configured to receive both selection commands and adjustment commands from the user interface.

As an example, in another embodiment, a portable lighting device configured to operate using a portable source of power is provided in which the portable lighting device comprises a light source, a main power circuit, an inertial sensor and a controller. The main power circuit electrically connects the light source to the portable source of power and includes an electronic power switch disposed electrically in series with the light source. The inertial sensor can be used to detect a plurality of predetermined positions and movements of the portable lighting device. The controller is electrically connected to the electronic power switch in a manner to permit the controller to control the flow of power through the electronic power switch and light source in the main power circuit. The controller is also electrically connected to the at least one output from the inertial sensor. The controller is programmed to control the flow of power through the electronic power switch (and hence the light source) based on one or more signals received from the at least one output of the inertial sensor. For example, the controller may be programmed to enter into a new mode of operation based on one of the plurality of predetermined positions and movements of the portable lighting device. In addition, the controller may be programmed to adjust a mode of operation based on the input received from the at least one input received from the inertial sensor. Further, the inertial sensor may, for example, comprise an accelerometer.

One potential method of operating a portable lighting device, such as a flashlight or headlamp, involves positioning the lighting device in a first predetermined position to cause the lighting device to enter a new mode of operation when the lighting device is turned on. The method may further include moving the lighting device in a predetermined manner to adjust the mode of operation. For example, the portable lighting device may be turned on by pressing the momentary switch for a predetermined period of time while the flashlight is in a predetermined position to cause it to enter a new mode of operation. The new mode of operation is determined by the orientation of the flashlight along the principle axis of projection of the light source while the flashlight is turned on. The above method is advantageous in that a new mode of operation may be selected without having to implement a series of press and release sequences of the main switch. In other embodiments, the first predetermined position may involve another orientation, such as orienting the portable lighting device in a predetermined vertical position.

Further aspects, objects, and desirable features, and advantages of the invention will be better understood from the following description considered in connection with the accompanying drawings in which various embodiments of the disclosed invention are illustrated by way of example. It is to be expressly understood, however, that the drawings are for the purpose of illustration only and are not intended as a definition of the limits of the invention.

### BRIEF DESCRIPTION OF THE DRAWINGS

FIG. 1 is a plan view of an exemplary flashlight.

FIG. 2 is a cross-sectional view of the flashlight of FIG. 1 taken along the plane indicated by Line 102-102.

FIG. 3 is an enlarged cross-sectional view of a forward section of the flashlight of FIG. 1 taken through the plane indicated by Line 102-102.

FIG. 4 is an enlarged cross-sectional view of a rearward section of the flashlight of FIG. 1 taken through the plane indicated by Line 102-102.

FIG. 5A is an exploded perspective view of the head assembly, barrel, lamp module, and battery pack of the flashlight of FIG. 1. FIG. 5B is an exploded perspective view of the switch and tail cap assembly portion of the flashlight of FIG. 1. FIG. 5C is a rear perspective view of the battery pack of the flashlight of FIG. 1.

FIG. 6 is a plan view of another exemplary flashlight.

FIG. 7 is a cross-sectional view of the flashlight of FIG. 6 taken along the plane indicated by Line 302-302.

FIG. 8 is an enlarged cross-sectional view of a forward section of the flashlight of FIG. 6 taken through the plane indicated by Line 302-302.

FIG. 9 is an enlarged cross-sectional view of a rearward section of the flashlight of FIG. 6 taken through the plane indicated by Line 302-302.

FIG. 10A is an exploded perspective view of the head assembly, barrel, lamp module, and battery cassette of the flashlight of FIG. 6. FIG. 10B is an exploded perspective view of the switch and tail cap assembly portion of the flashlight of FIG. 6. FIG. 10C is a rear perspective view of the battery cassette of the flashlight of FIG. 6.

FIG. 11A is a side view of a tail cap of the flashlight of FIG. 6. FIG. 11B is a rear view of a tail cap of the flashlight of FIG. 6 showing an exemplary orientation of icons.

FIG. 12 is a circuit block diagram illustrating the relationship between the electronic circuitry according to one embodiment of the invention.

FIGS. 13A-D are schematic circuit diagrams of different components of the circuit shown in FIG. 12.

FIGS. 14-17 are flow diagrams illustrating methods of controlling the operation of a flashlight according to different aspects of the invention.

### DETAILED DESCRIPTION

Embodiments will now be described with reference to the drawings. To facilitate the description, any reference numeral representing an element in one figure will represent the same element in any other figure. Further, in the following description, references to the front, forward or forward facing side of a component shall generally mean the side of the component that faces toward the front end of the flashlight or other portable lighting device. Similarly, references to the aft, back, rear or rearward facing side of a component shall generally mean the side of the component facing the rear of the portable lighting device, e.g., the direction in which the tail cap is located in the case of a flashlight.

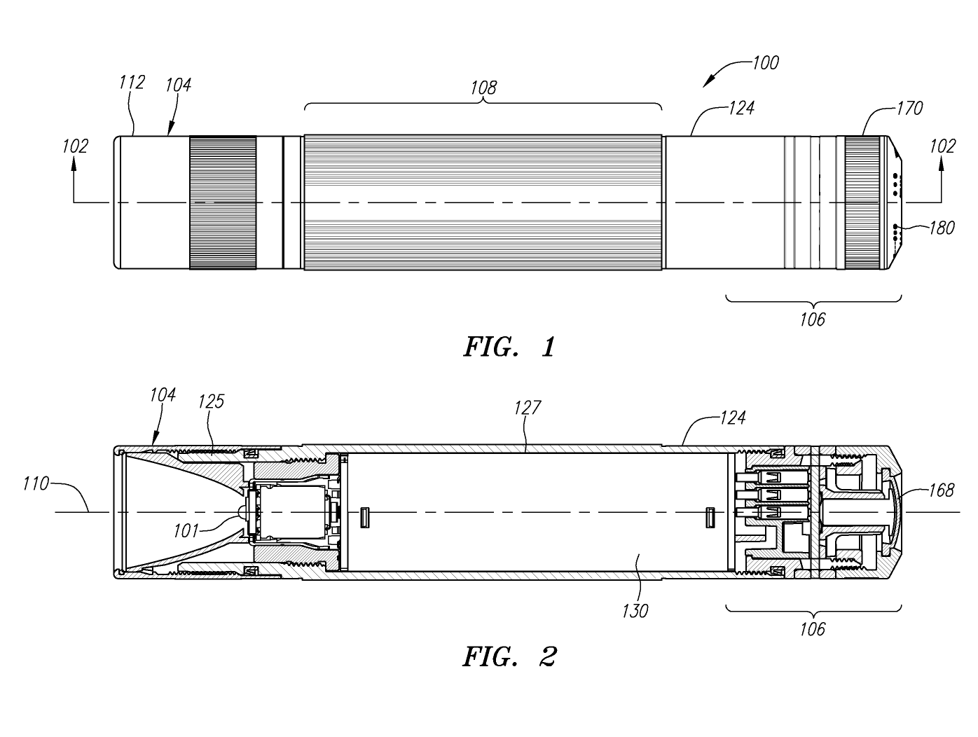

Exemplary flashlights 100, 300 are described in connection with FIGS. 1-5B and 6-13, respectively. Each of the exemplary flashlights 100, 300 incorporate a number of distinct aspects. While these distinct aspects have all been incorporated into flashlights 100, 300 in various combinations, the scope of the present invention is not restricted to flashlights 100, 300. Rather, the present invention is directed to each of the inventive features of flashlights 100, 300 described below both individually as well as in various combinations. Further, as will become apparent to those skilled in the art after reviewing the present disclosure, one or more aspects of the present invention may also be incorporated into other portable lighting devices, including, for example, head lamps and lanterns.

FIG. 1 shows an exemplary flashlight 100. The exemplary flashlight 100 generally includes barrel 124, head assembly 104 located at the forward end of barrel 124, and switch and tail cap assembly 106 located at the rear end of barrel 124. The head assembly 104 is disposed about the forward end of the barrel 124, and the switch and tail cap assembly 106 encloses the aft end of barrel 124.

Barrel 124 may include a textured surface 108 along a portion of its length for a user to grip. In the present embodiment, textured surface 108 may be provided by broaching. Alternatively, textured surface 108 may comprise a knurled or machine surface. Any desired pattern may be used for textured surface 108.

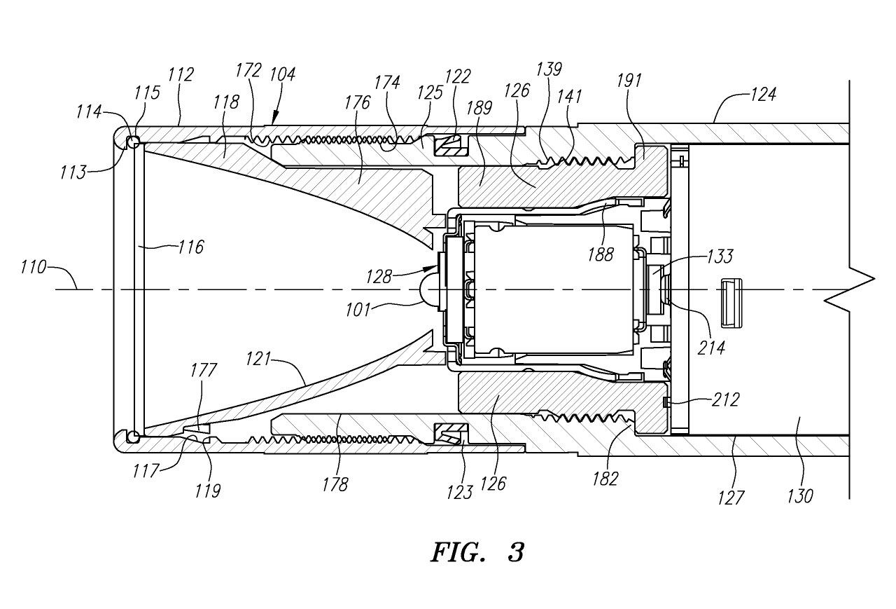

FIG. 2 is a partial cross-sectional view of flashlight 100 of FIG. 1 taken along the plane indicated by line 102-102. FIG. 3 is an enlarged partial cross-sectional view of a forward section of flashlight 100 of FIG. 1 taken through the plane indicated by line 102-102. (The portions of FIGS. 2-4 that relate to the battery pack 130 are not shown in cross-section.)

Referring to FIGS. 2 and 3, a light source 101 is mounted to the forward end of the barrel 124. In the present embodiment, the light source 101 is mounted so that it is disposed at the aft end of reflector 118. In other embodiments, the reflector 118 may be omitted, or its shape changed.

Barrel 124 is a hollow, tubular structure suitable for housing a portable source of power, such as, for example, rechargeable battery pack 130. Thus, barrel 124 serves as a housing for receiving a portable source of power having a positive and a negative electrode or terminal.

In the illustrated embodiment, barrel 124 is sized to accommodate battery pack 130, which contains a single Li-Ion battery cell. In other embodiments, however, the battery pack 130 may be omitted and the barrel 124 sized to accommodate one or more alkaline dry cell or rechargeable batteries of desired size and capacity. Further, if a plurality of batteries is employed, depending on the implementation, the batteries may be connected electrically in parallel or series. Other suitable portable power sources, including, for example, high capacity storage capacitors may also be used.

In the illustrated embodiment, barrel 124 includes a forward portion 125 that extends beneath combined head and face cap 112 so that the outer surface of the head assembly 104 is generally flush with that of the barrel 124. The inner diameter of the forward portion 125 is smaller than the inner diameter of the rest of barrel 124. Also, the outer diameter of at least a portion of the forward portion 125 may be smaller than the outer diameter of the rest of barrel 124, so that when flashlight 100 is assembled, the outer portion of combined head and face cap 112 and the outer portion of barrel 124 may form a substantially uniform, cylindrical surface. Alternatively, the combined head and face cap 112 and barrel 124 may have different shapes.

Barrel 124 is preferably made out of aluminum, but other suitable metal or non-metal (e.g. plastic) materials may also be used. Although barrel 124 is preferably made out of aluminum, in the embodiment of flashlight 100 described below, barrel 124 is not used as an electrical path for connecting either the light source 101 or circuit board 148 to the battery pack 130. As a result, barrel 124 does not form part of the main power circuit for either the light source 101 or circuit board 148. In other embodiments, however, the barrel 124 may comprise part of the main power circuit for light source 101 and/or circuit board 148, such as where one or more batteries are used in place of battery pack 130. In such embodiments, barrel 124 and other components preferably comprise a conductive material forming a conductive path.

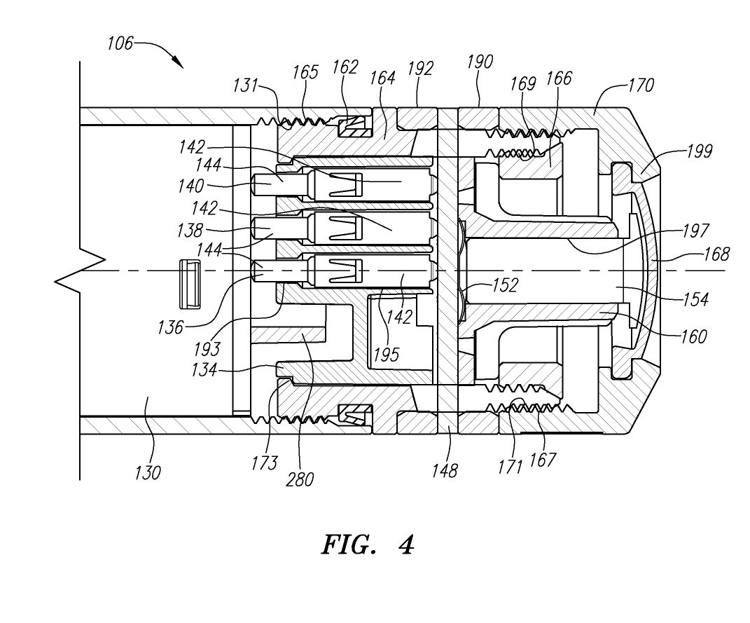

In the illustrated embodiment, barrel 124 includes external threads 174 formed on the outer diameter of the forward portion 125, internal threads 139 formed on the inner diameter of the forward portion 125, and internal threads 131 formed on the inside diameter of its aft end (best seen in FIG. 4). The barrel 124 of the present embodiment also includes an annular shoulder 182 formed at the aft end of the forward portion 125. Annular shoulder 182 acts as a stop for shoulder ring 126 disposed in the forward end of barrel 124.

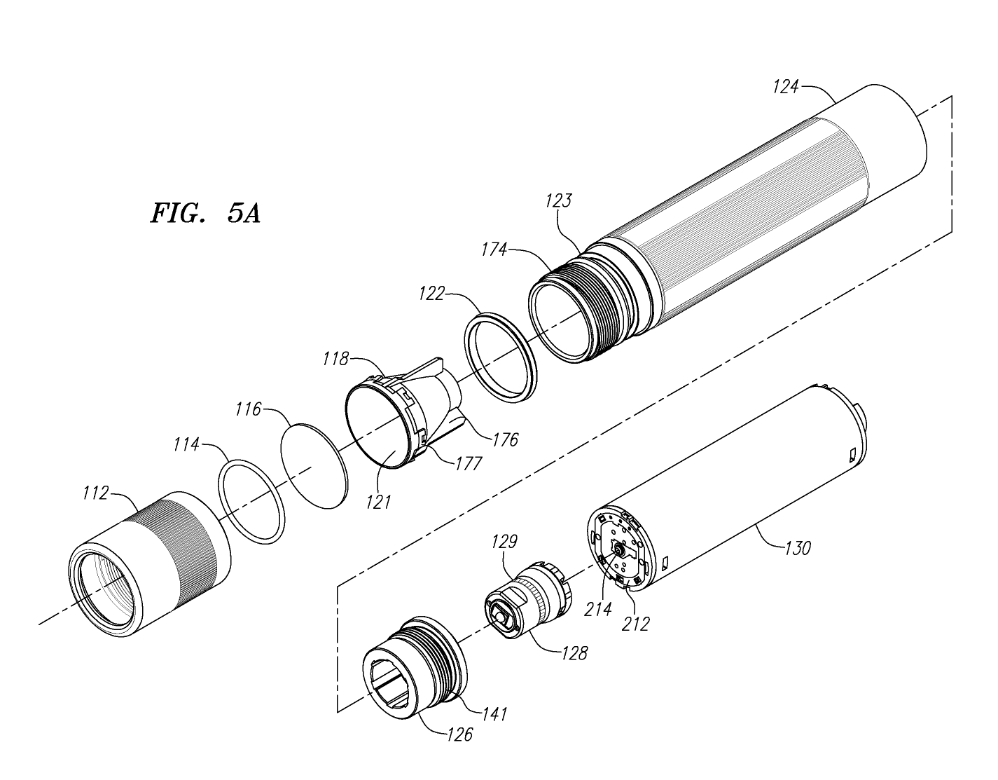

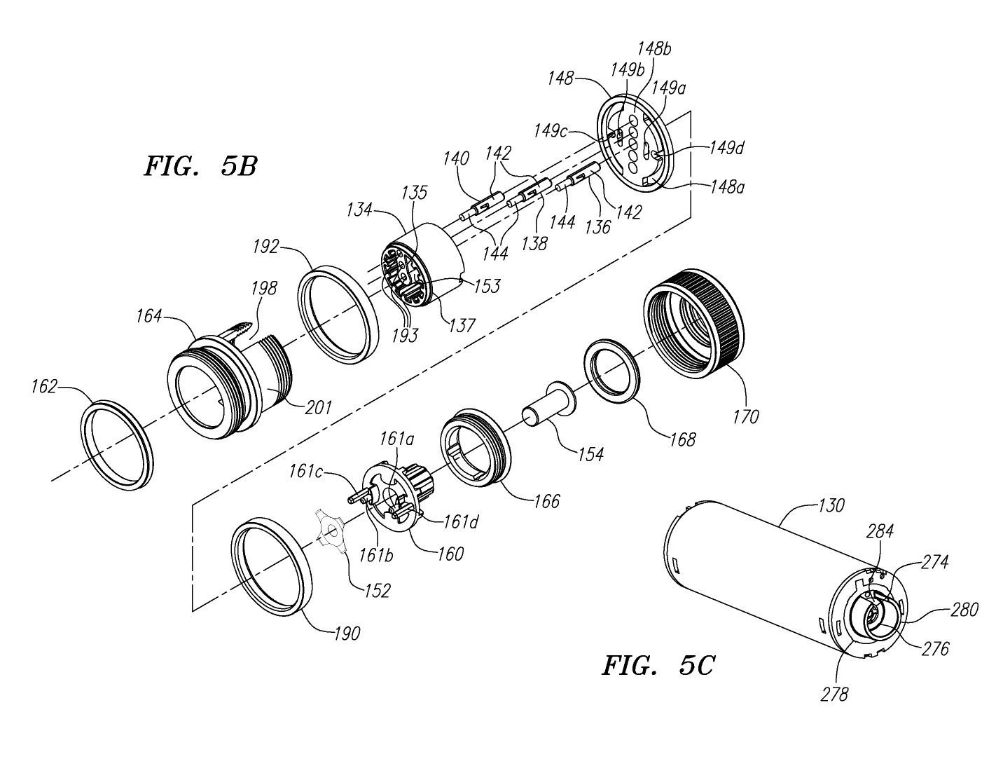

FIG. 5A is an exploded perspective view of head assembly 104, barrel 124, lamp module 126, and battery pack 130 of flashlight 100 of FIG. 1. Referring to FIGS. 3 and 5A, head assembly 104 of the present embodiment includes combined head and face cap 112, lens 116, and reflector 118. In other embodiments, however, head and face cap 112 may comprise two or more separate component parts that may be assembled together, for example, with mating threads.

The internal surface of combined head and face cap 112 may be used to house certain components, including, for example, lens 116 and reflector 118. Reflector 118 and lens 116 are operatively mounted to the inner diameter of the combined head and face cap 112. In the present embodiment, reflector 118 includes spring clips 177 extending from its front end and distributed evenly around the outer circumference of reflector 118 so that reflector 118 may snap into a corresponding annular recess 117 formed near the forward end of the inner portion of combined head and face cap 112. In the present embodiment, six spring clips 177 are employed. Other embodiments, however, may employ a different number of spring clips 177 or another means altogether for attaching reflector 118 to combined head and face cap 112.

An annular shoulder 119 is provided at the aft end of annular recess 117 to attach reflector 118 to the combined head and face cap 112 once spring clips 177 expand into annular recess 117.

Lens 116 is interposed between a forward facing flange of reflector 118 and a lip 313. In this manner, reflector 118 and lens 116 are locked within the combined head and face cap 112. In one implementation, a sealing element, such as an o-ring 114, may be located at the interface between the lens 116 and lip 313. Other water resistant means, such as a one-way valve, may also be used. O-ring 114 may comprise rubber or other suitable material.

An annular groove 115 may be provided in the head and face cap 112 so that it is disposed at the interface between the lens 116 and lip 113. The annular groove 115 is preferably sized to partially receive o-ring 114, thereby properly positioning o-ring 114 during the assembly process.

Reflector 118 may include fins 176 distributed around the outer perimeter of reflector 118 to provide structural integrity to reflector 118 and to help properly align reflector 118 within the internal surface of the head and face cap 112 and the forward portion 125 of barrel 124. In the present embodiment, three fins 176 are employed. In other embodiments, a different number of fins 176 may be used, or no fins at all may be used.

Combined head and face cap 112 may include internal threads 172 configured to engage with external threads 174 on the forward portion 125 of barrel 124. In other implementations, however, other forms of attachment may be adopted. Further, combined head and face cap 112 is preferably made from anodized aluminum, though other suitable materials may also be used.

As best seen in FIGS. 3 and 5A, the reflective profile 121 of the reflector 118 is preferably a segment of a computer-generated optimized parabola that is metallized for reflectivity and to ensure high precision optics. Preferably the profile 121 is defined by a parabola having a focal length of less than 0.080 inches, and more preferably between 0.040-0.050 inches. Further, the distance between the vertex of the parabola defining the profile 121 and the aft opening of the reflector 121 is preferably 0.070-0.120 inches, more preferably 0.075-0.085 inches. The opening of the forward end of the reflector 118 preferably has a diameter of 0.8-0.9 inches, more preferably 0.850-0.852 inches, and the opening of the aft end of the reflector 118 preferably has a diameter of 0.2-0.3 inches, more preferably 0.240 to 0.250 inches. Further, the ratio between the distance from the vertex to the opening of the aft end of the reflector 118 and the focal length is preferably in the range of 1.5:1 and 3.5:1, more preferably 1.6:1 to 1.8:1. Moreover, the ratio between the distance from the vertex to the opening of the forward end of the reflector 118 and the focal length is preferably in the range of 20:1 and 35:1, more preferably 20:1 to 21:1.

Reflector 118 preferably comprises an injection molded plastic, though other suitable materials may be used.

Referring back to FIG. 3, although the embodiment disclosed herein illustrates a substantially planar lens 116, the flashlight 100 may instead include a lens that has curved surfaces to further improve the optical performance of the flashlight 100. For example, the lens may include a biconvex profile or a plano-convex profile in the whole or part of the lens surface.

Referring to FIGS. 3 and 5A, a sealing element 122 may be provided at the interface between combined head and face cap 112 and forward portion 125 of barrel 124 to provide a watertight seal. Preferably sealing element 122 is located in an annular groove 123 provided in the outer surface of the barrel 124. The sealing element 122 may be an O-ring or other suitable sealing device. In the illustrated embodiment, the sealing element 122 is a one-way valve formed by a lip seal that is orientated so as to prevent flow from the outside into the interior of the flashlight 100, while simultaneously allowing overpressure within the flashlight to escape or vent to the atmosphere.

The design and use of one-way valves in flashlights are more fully described in U.S. Pat. No. 5,003,440 issued to Anthony Maglica, which is hereby incorporated by reference.

Flashlight 100 of the present embodiment includes a lamp module 128 mounted within the shoulder ring 126 at the forward end of barrel 124 so that light source 101 is disposed at the aft end of reflector 118. Lamp module 128 may have a principal axis 110 of projection which may coincide with the reflector axis and/or the longitudinal axis of flashlight 100. In view of the foregoing arrangement, the focus of light emitted from lamp module 128 may be adjusted by twisting head assembly 104 relative to barrel 124, which may be accomplished via mating threads 172, 174, to cause translation of the head assembly 104 away from or toward lamp module 128.

The light source 101 of lamp module 128 includes a first, positive electrode and a second, negative electrode. The first positive electrode is in electrical communication with a compressible positive contact 133 (see FIG. 3). The second, negative electrode is in electrical communication with the heat sink housing 188, which also acts as the negative contact of lamp module 128.

The light source 101 may be any suitable device that generates light. For example, the light source 101 can be an LED lamp, an incandescent lamp, or an arc lamp. In the illustrated embodiment, the light source 101 is an LED lamp and lamp module 128 is an LED module. The LED of lamp module 128 preferably substantially radiates light at a spherical angle of less than 180°. In other embodiments, LEDs with other angles of radiation may be used, including LEDs that radiate at an angle greater than 180°.

The structure of an LED module that may be used for lamp module 128 is described in detail in co-pending U.S. patent application Ser. No. 12/188,201, filed Aug. 7, 2008, by Anthony Maglica and U.S. Provisional Patent Application Ser. No. 61/145,120, filed Jan. 16, 2009, by Stacey West et al., the contents of both of which are hereby incorporated by reference.

Referring to FIG. 3, shoulder ring 126 is configured to be in intimate contact with the barrel 124. In the present embodiment, the outer diameter of forward portion 126 is provided with external threads 141 which are sized to threadably mate with internal threads 139 of the forward portion 125 of barrel 124. In other embodiments, other means for attaching or mounting the shoulder ring 126 to the interior surface of barrel 124 may be employed, including, for example, press-fitting.

Lamp module 128 is preferably mounted within shoulder ring 126 via a press-fit operation. Further, the outer surface of heat sink housing 188 is preferably shaped to mate with the inner surface of shoulder ring 126 along as much surface area as possible to facilitate electrical and thermal communication between the lamp module 128 and the shoulder ring 126 and the interference fit between the two. A knurled surface 129, preferably arranged around the circumference of lamp module 128, may also be provided to enhance the interference fit between the lamp module 128 and shoulder ring 126.

As shown in FIG. 3, the shoulder ring 126 forms a large heat sink. Moreover, because it has a mass that is substantially greater than that of lamp module 128, it quickly draws heat away from lamp module 128 via heat sink 188. Ultimately, the heat drawn away by shoulder ring 126 is efficiently drawn into barrel 124 because barrel 124 and shoulder ring 126 are in intimate contact in the forward region 189 of shoulder ring 126. Shoulder ring 126 may be made out of metal, and more preferably nickel plated aluminum for enhanced thermal, electrical and corrosion resistance properties.

The outer diameter of the aft region 191 of shoulder ring 126 is slightly smaller than the inner diameter of the rear portion of barrel 124. Therefore, during assembly, shoulder ring 126 can readily slide within barrel 124 without damaging any protective coating, such as that resulting from an anodizing treatment process. On the other hand, the outer diameter of the aft region 191 of shoulder ring 126 is greater than the inner diameter of the forward portion 125 of barrel 124. Therefore, the aft region 191 of shoulder ring 126 serves as a stop to limit the forward-most position of shoulder ring 126 as the shoulder ring is threaded into internal threads 139 of barrel 124.

While shoulder ring 126, lamp module 128, and head assembly 104 do not form part of a mechanical switch for flashlight 100 in the present embodiment, in other embodiments they could as described, for example, in connection with U.S. patent application Ser. No. 12/353,396, Jan. 14, 2009, by Stacey West, the contents of which are hereby incorporated by reference.

Lamp module 128 is electrically coupled to flashlight 100 as follows. Flashlight 100 may include rechargeable battery pack 130 that includes positive top contact 214 which is electrically coupled to compressible positive contact 133 of lamp module 128. After the current passes through the light source 101, a ground connection extends from the negative electrode of the light source 101 through heat sink housing 188, which acts as the negative contact of lamp module 128 and shoulder ring 126, which in turn is electrically coupled to the negative contact 212 of battery pack 130.

FIG. 4 is an enlarged partial cross-sectional view of a rear section of flashlight 100 of FIG. 1 taken through the plane indicated by line 102-102. (In FIG. 4, however, battery pack 130 is not shown in cross-section.) The rearward section of flashlight 100 generally comprises switch and tail cap assembly 106. FIG. 5B is an exploded perspective view of switch and tail cap assembly 106.

Referring to FIGS. 4 and 5B, switch and tail cap assembly 106 of the present embodiment preferably includes sealing element 162, such as a one-way valve, inner tail cap section 164, commutating rings 190, 192, lower switch housing 134, spring probe assemblies 136, 138, 140, circuit board 148, snap dome 152, upper switch housing 160, locknut 166, actuator 154, switch port seal 168, and outer tail cap section 170.

Each spring probe assembly 136, 138, 140 comprises a conductive plunger 144 slidably disposed within a conductive barrel 142, and a spring (not shown) positioned between the plunger 144 and barrel 142 to bias the plunger 144 away from the barrel 142.

Lower switch housing 134 preferably includes three cylindrical channels 193 opened to the forward end of lower housing 134 for receiving and holding at least a portion of the plunger 144 of each spring probe assembly 136, 138, 140. Each of the channels 193 is connected to a cylindrical chamber 195 which is axially aligned with the channel 193. The diameter of each cylindrical chamber 195 is larger than each channel diameter so that each chamber may receive and house the barrel 142 of each spring probe assembly 136, 138, 140. In the present embodiment, cylindrical channels 193 of lower switch housing 134 are formed in an ear 135 projecting radially inward from the outer wall 137 of lower switch housing 134. In the present embodiment, ear 135 is at least partially surrounded by a recess 153 for receiving a mating indexing feature 280 provided on the aft end of battery pack 130. In other embodiments, a male indexing feature may be provided on the lower switching housing 134 and a female indexing feature may be provided on the battery pack 130.

In the present embodiment, lower switch housing 134 preferably comprises a non-conductive material, such as plastic, but other suitable materials or materials systems may also be used.

In the present embodiment, the barrels 142 and plungers 144 of spring probe assemblies 136, 138, 140 preferably comprise a conductive metal, such as a copper alloy or aluminum.

The channels 193 of lower switch housing 134, and therefore, spring probe assemblies 136, 138, 140, are configured to align with contacts on the bottom side of battery pack 130. Referring also to FIG. 5C, when battery pack 130 is installed, spring probe assembly 136 may be aligned with a bottom central contact 274 of battery pack 130, spring probe assembly 138 may be aligned with a bottom middle ring contact 276 of battery pack 130, and spring probe assembly 140 may be aligned with a bottom outer ring contact 278 of battery pack 130. In one embodiment, spring probe assemblies 136, 138, 140 are electrically coupled to a GND, a MOM contact, and a +5 VDC contact of battery pack 130, respectively.

In the present embodiment, circuit board 148 has slots 148a (shown in FIG. 5B) for receiving the rearward extending portion 201 of the inner tail cap portion 164. On the other hand, the slots 198 formed by the rearward extending portion 201 of the inner tail cap portion 164 are used to receive a solid portion 148b of circuit board 148, thereby holding circuit board 148 and the inner tail cap portion 164 in desired relatively position.

Circuit board 148 preferably includes contacts on both of its sides. Circuit board 148 may also include conductive vias routed through board 148 to couple contacts on opposite sides. In the present embodiment, the front side of circuit board 148 (which is facing lower switch housing 134) includes three contact pads that are electrically coupled to spring probe assemblies 136, 138, 140, respectively. The rear side of circuit board 148 (which is facing the upper switch housing 160) includes three corresponding contact pads that are located at designated locations. Each pair of the corresponding contacts on the front side and rear side of circuit board 148 are electrically connected through conductive vias provided in circuit board 148, or alternatively routing wires.

Upper switch housing 160 includes a cylindrical channel 197 that allows actuator 154 to slide within. An annular rim of switch port seal 168 is held between an annular lip 199 of outer tail cap 170, which is located at the rear end of flashlight 100. When a user presses on switch port seal 168, actuator 154 is moved forward within channel 197 and engages snap dome 152 such that MOM and GND contact pads on the rear side of circuit board 148 are electrically coupled through snap dome 152. When the user releases switch port seal 168, the MOM and GND contact pads on the rear side of circuit board 148 are no longer electrically coupled through snap dome 152. In other embodiments, non-mechanical switches, for example, capacitors, may be used.

Upper switch housing 160 preferably includes a set of keys 161a, 161b, 161c and 161d (shown in FIG. 5B). These keys 161a, 161b, 161c and 161d may be used to plug into slots 149a, 149b, 149c and 149d, respectively, on circuit board 148 to align upper switch housing 160 and circuit board 148 in desired relative position.

In the present embodiment, upper switch housing 160 and actuator 154 preferably comprise a non-conductive material such as plastic. Switch port seal 168 preferably comprises a flexible non-conductive material, such as rubber. Snap dome 152 preferably comprises a conductive spring metal. Other suitable material may be used.

Commutating rings 190, 192 are provided at the middle of switch and tail cap assembly 106. While commutating rings 190, 192 are provided in the present embodiment in the form of charging rings to simplify the recharging procedure, in other embodiments, commutating rings 190, 192 may take on other forms. In the present embodiment, circuit board 148 is interposed between commutating rings 190, 192. Circuit board 148 is configured to be in electrical communication with commutating rings 190, 192, while simultaneously isolating commutating rings 190, 192 from direct electrical communication with one another through a short circuit. Electrical communication between circuit board 148 and commutating rings 190, 192 may be established by providing a conductive trace at the interface formed between circuit board 148 and each of the commutating rings. Commutating rings 190, 192 are preferably aluminum rings.

As best seen from FIGS. 4 and 5B, commutating rings 190, 192 serve as the interface between an external recharging unit and rechargeable battery pack 130 of flashlight 100. Although not depicted here, those skilled in the art will appreciate that the cradle of the recharging unit should be fashioned in a way to make electrical contact with commutating rings 190, 192 and hold flashlight 100 in place while charging takes place. Because commutating rings 190, 192 preferably extend around the entire external circumference of flashlight 100, a recharging unit having a simple cradle design may be used. For example, a cradle design that permits flashlight 100 to be placed into the recharging unit in any radial orientation relative to its longitudinal axis and still be able to make contact with the recharging unit's charging contacts may be used. Thus, flashlight 100 does not need to be pressed into the charging unit so that hidden plugs or tabs are inserted into flashlight 100 in order to make contact with the charging contacts of the recharging unit.

Inner tail cap section 164 preferably includes threads 165 on the front outer surface of inner tail cap section 164 for mating with threads 131 on the rear inner surface of barrel 124. In addition, inner tail cap section 164 preferably includes threads 167 on the aft outer surface of inner tail cap section 164 for mating with threads 171 on the front inner surface of the outer tail cap section 170.

The inner tail cap section 164 of the present embodiment also includes an annular shoulder 173 formed at the front end of the inner tail cap section 164. Annular shoulder 173 serves as a stop to prevent lower switch housing 134 from moving forward.

Locknut 166 is preferably threaded into and mated with thread 169 on the aft inner surface of inner tail cap section 164. Therefore, locknut 166, annular shoulder 173 of the inner tail cap section 164, and threads 165, 131, 167, 171, 169 function together to integrate the switch and tail cap assembly 106.

The construction of inner tail cap section 164 should be such as to maintain the commutating rings 190, 192 in electrical isolation from one another. In other words, inner tail cap section 164 should not provide a short circuit path between commutating rings 190, 192. Thus, for example, inner tail cap section 164 may be constructed from anodized aluminum or some other electrically non-conductive material. Locknut 166 may be made from metal or plastic and is not required to be conductive as it does not form part of any electrical path in the present embodiment.

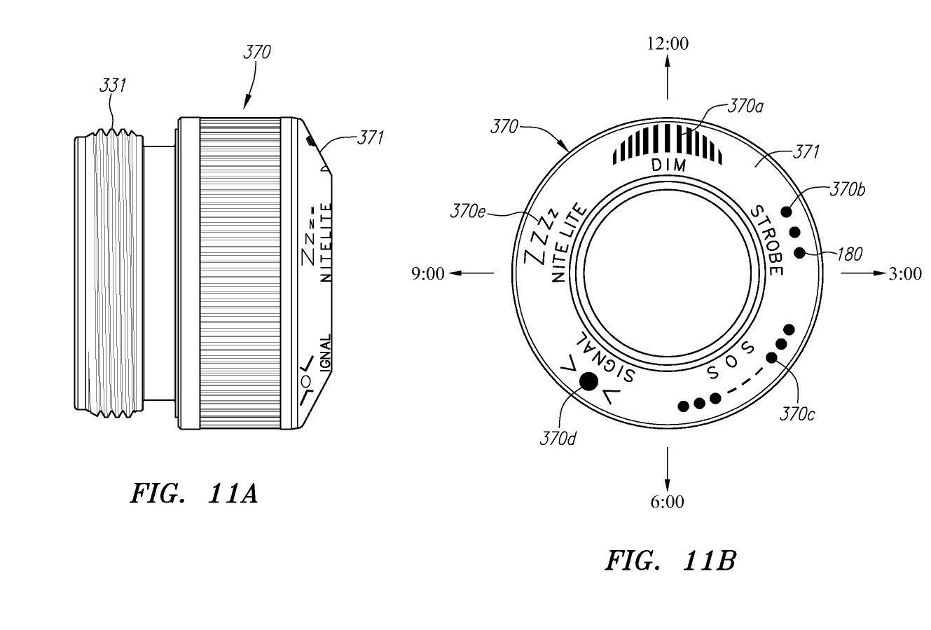

The rear end of the outer tail cap section 170 preferably has a plurality of icons 180 (best shown in FIG. 11B) to be used as indications for functional mode selection. The icons 180 and their corresponding functional modes together with the operation procedures will be described in connection with the description of flashlight 300 later.

A one-way valve, such as a lip seal 162, may be provided at the interface between barrel 124 and inner tail cap section 164 to provide a watertight seal while simultaneously allowing overpressure within flashlight 100 to vent to the atmosphere. The design and use of one-way valves in flashlights are more fully described in U.S. Pat. No. 5,003,440 issued to Anthony Maglica, which is hereby incorporated by reference. However, other forms of sealing elements, such as an o-ring, may be used instead of lip seal 162 to form a watertight seal. Lip seal 162 preferably comprises a non-conductive material such as rubber.

Other configurations of switch and tail cap assembly 106 may be used. For example, the switch function may be included in a side, push button switch or in an internal rotating head assembly switch such as that employed in U.S. patent application Ser. No. 12/353,396, filed Jan. 14, 2009.

Referring now to FIGS. 5A and 5C, the rechargeable battery pack 130 is now further described. In general, battery pack 130 preferably includes a rechargeable battery, a circuit board containing electronics such as recharging circuit and/or circuits for other functions and contacts to electrically connect battery pack 130 to the rest of the flashlight 100 or other lighting device. As such, battery pack 130 may generally represent a self-contained unit that may be inserted into battery compartment 127 of barrel 124 along with other components shown in FIG. 5A. It is also preferred that battery pack 130 provides protection for the electronics and other components therein. In other embodiments, battery pack 130 do not have a circuit board mounted with components such as accelerometer 1058, therefore, functions can be provided by circuit board 148 in the switch and tail cap assembly 106.

Referring to FIG. 5C, the rear end of battery pack 130 includes a bottom central contact 274, a bottom middle ring contact 276, and a bottom outer ring contact 278. An indexing feature 280 formed from a rearward extending wall may be located on the aft end of battery pack 130, such as between the bottom middle ring contact 276 and the bottom outer ring contact 278. A slot 284 provided in the indexing feature 280 is sized to receive the ear 135 of the lower switch housing 134 so that indexing feature 280 may be received within recessed area 153 surrounding ear 135 of the lower switch housing 134, thereby, forming a plug and socket type connection. As a result, when the switch and tail cap assembly 106 is rotated to screw it into barrel 124, battery pack 130 will also be rotated once indexing feature 280 is received within recess 153. Therefore, the desired orientation of the switch and tail cap assembly 106 and an assembly circuit board (not shown) in battery pack 130 will remain aligned at all time. This feature is helpful when accelerometer 1058 discussed below is located in the assembly circuit board of battery pack 130 so that the orientation of icons 180 can be automatically detected based on the output of accelerometer 1058.

Battery pack 130 provided by the exemplary flashlight 100 is described in detail in co-pending U.S. Provisional Patent Application Ser. Nos. 61/145,120, filed Jan. 16, 2009, by Stacey West et al., the contents of which were incorporated by reference above.

The electrical circuits of flashlight 100 and the functions they serve are now further described. The electrical circuits of flashlight 100 include a load circuit to power the light source 101, a controller circuit for powering the controller and other electronics on circuit board 148 and, if available, in battery pack 130, and a charging circuit for recharging rechargeable battery in battery pack 130.

When battery pack 130 is installed into battery compartment 127 of barrel 124 a completed electrical path for the light source 101 (or electrical load) may be formed from the top positive contact 214 of battery pack 130 to the positive contact 133 of lamp module 128 and through the light source. This electrical path then extends from heat sink housing 188 of lamp module 128 to the should ring 126 and then to the top outer ring contact 212 of battery pack 130.

The control circuit starts from a bottom outer ring positive contact of battery pack 130 to spring probe assembly 140 to circuit board 148, and return from a ground pad of circuit board 148 to spring probe assembly 136 to central ground contact of battery pack 130.

The high side of the charging circuit to battery pack 130 extends from positive charging ring 190, to circuit board 148, spring probe assembly 140, into battery pack 130 via an outer bottom ring contact 270 of battery pack 130. The charging circuit may then return from a bottom negative contact 274 of battery pack 130 to spring probe assembly 136, circuit board 148, to ground charge ring 192.

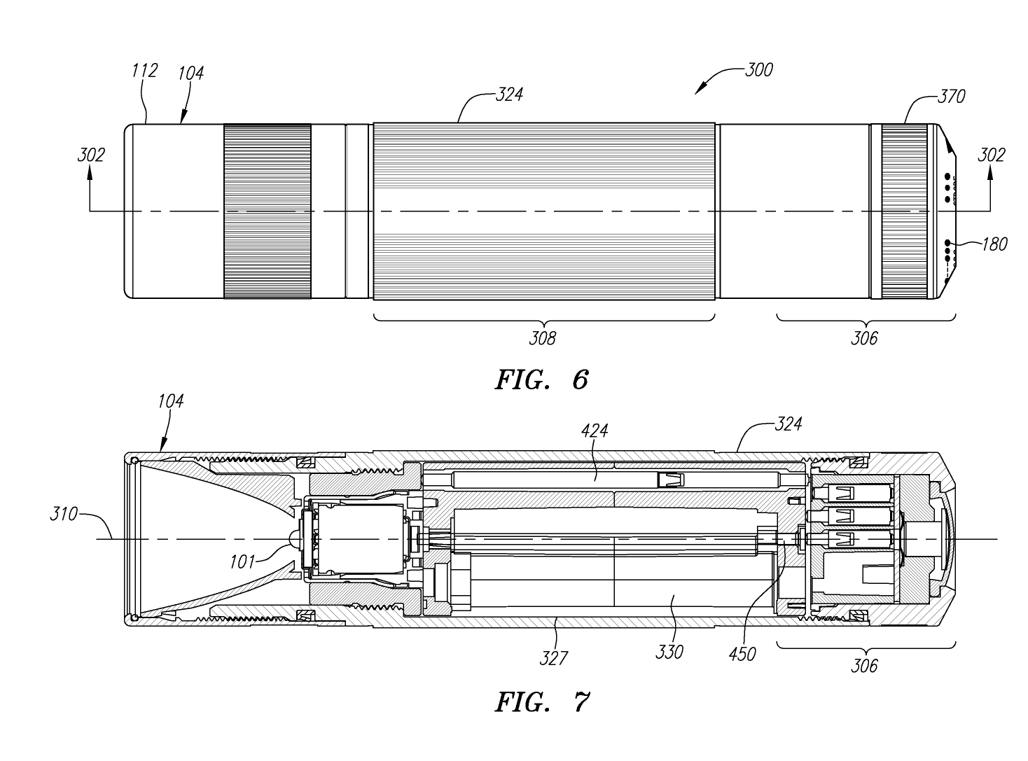

Another preferred flashlight embodiment 300 is now described with reference to FIG. 6. As shown, flashlight 300 generally includes barrel 324, head assembly 104 located at the forward end of barrel 324, and switch and tail cap assembly 306 located at the rear end of barrel 324. The head assembly 104 is disposed about the forward end of the barrel 324, and the switch and tail cap assembly 306 encloses the aft end of barrel 324.

Barrel 324 may include a textured surface 308 along a portion of its length for a user to grip. Textured surface 308 may be provided by broaching. Alternatively, textured surface 108 may comprise a knurled or machine surface. Any desired pattern may be used for textured surface 108.

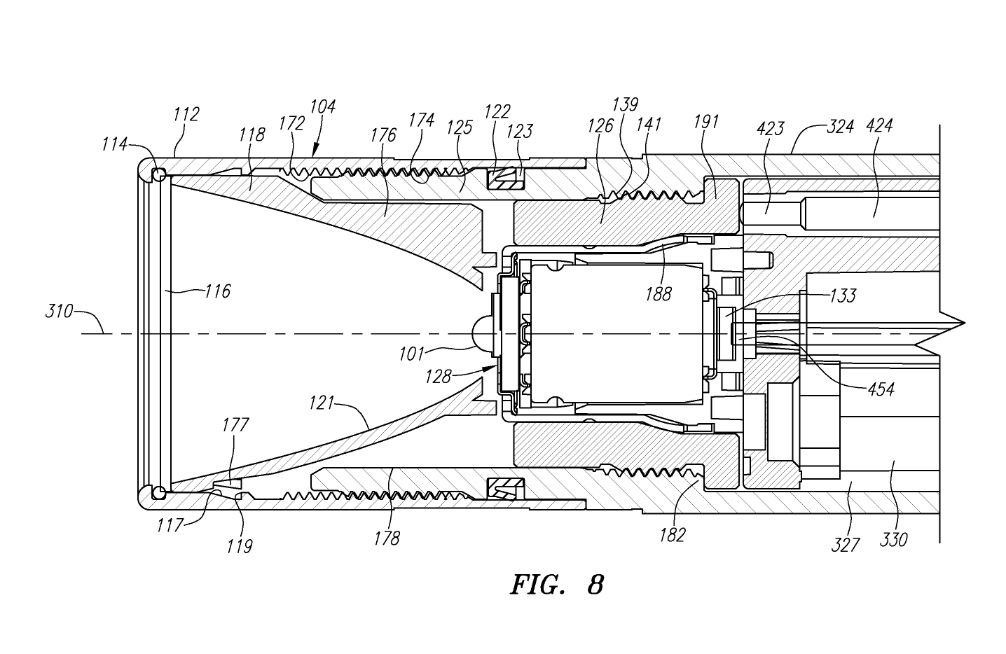

FIG. 7 is a partial cross-sectional view of flashlight 300 of FIG. 6 taken along the plane indicated by line 302-302. FIG. 8 is an enlarged partial cross-sectional view of a forward section of flashlight 300 of FIG. 6 taken through the plane indicated by line 302-302. (The portions of FIGS. 7-9 that relate to the battery cassette 330 are not shown in cross-section.)

Barrel 324 is a hollow, tubular structure suitable for housing a portable source of power, such as, for example, battery cassette 330. Thus, barrel 324 serves as a housing for receiving a portable source of power having a positive and a negative electrode or terminal.

In the illustrated embodiment, barrel 324 is sized to accommodate battery cassette 330. In other embodiments, however, the battery cassette 330 may be omitted and the barrel 324 sized to accommodate one or more alkaline dry cell or rechargeable batteries of desired size and capacity. Further, if a plurality of batteries is employed, depending on the implementation, the batteries may be connected electrically in parallel or series. Other suitable portable power sources, including, for example, high capacity storage capacitors may also be used.

In the illustrated embodiment, barrel 324 includes a forward portion 125 that extends beneath combined head and face cap 112 so that the outer surface of the head assembly 104 is generally flush with that of the barrel 324. The inner diameter of the forward portion 125 is smaller than the inner diameter of the rest of barrel 324. Also, the outer diameter of at least a portion of the forward portion 125 may be smaller than the outer diameter of the rest of barrel 324, so that when flashlight 300 is assembled, the outer portion of combined head and face cap 112 and the outer portion of barrel 324 may form a substantially uniform, cylindrical surface. Alternatively, the combined head and face cap 112 and barrel 324 may have different shapes.

Barrel 324 is preferably made out of aluminum, but other suitable metal or non-metal (e.g. plastic) materials may also be used. Although barrel 324 is preferably made out of aluminum, in the embodiment of flashlight 300 described below, barrel 324 is not used as an electrical path for connecting either the light source 101 or circuit board 348 to the battery cassette 330. As a result, barrel 324 does not form part of the main power circuit for either the light source 101 or circuit board 348. In other embodiments, however, the barrel 324 may comprise part of the main power circuit for light source 101 and/or circuit board 348, such as where one or more batteries are used in place of battery cassette 330. In such embodiments, barrel 324 and other components preferably comprise a conductive material, or include a conductive path.

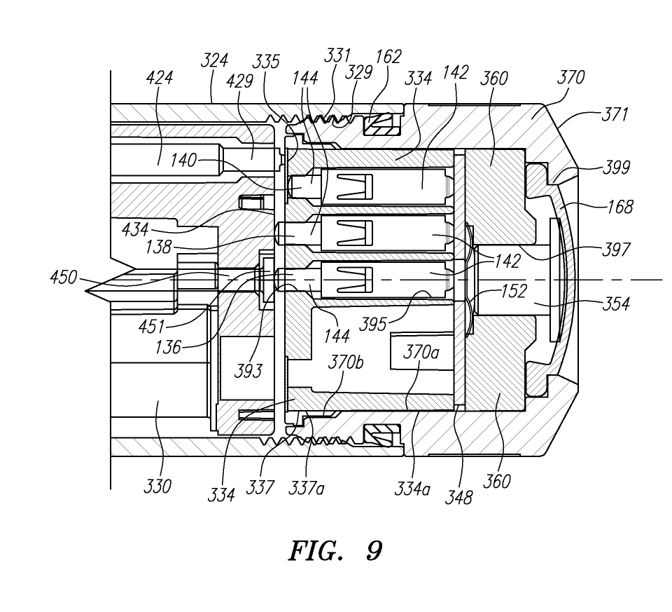

In the illustrated embodiment, barrel 324 includes external threads 174 formed on the outer diameter of the forward portion 125, internal threads 139 formed on the inner diameter of the forward portion 125, and internal threads 331 formed on the inside diameter of its aft end (best seen in FIG. 9). The barrel 324 of the present embodiment also includes an annular shoulder 182 formed at the aft end of the forward portion 125. Annular shoulder 182 acts as a stop for shoulder ring 126 disposed in the forward end of barrel 124

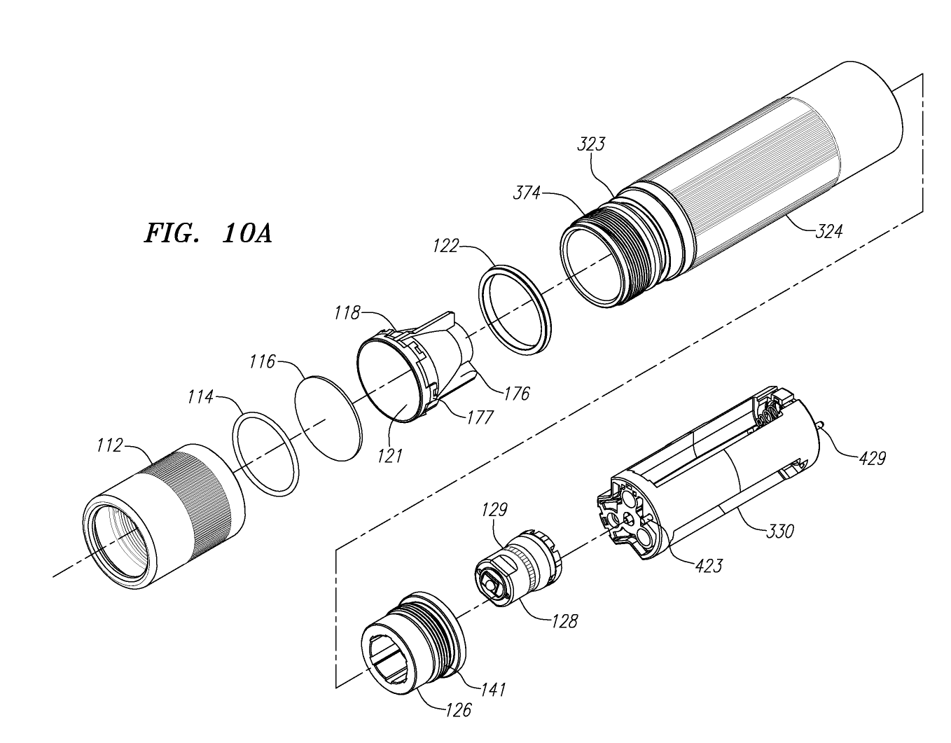

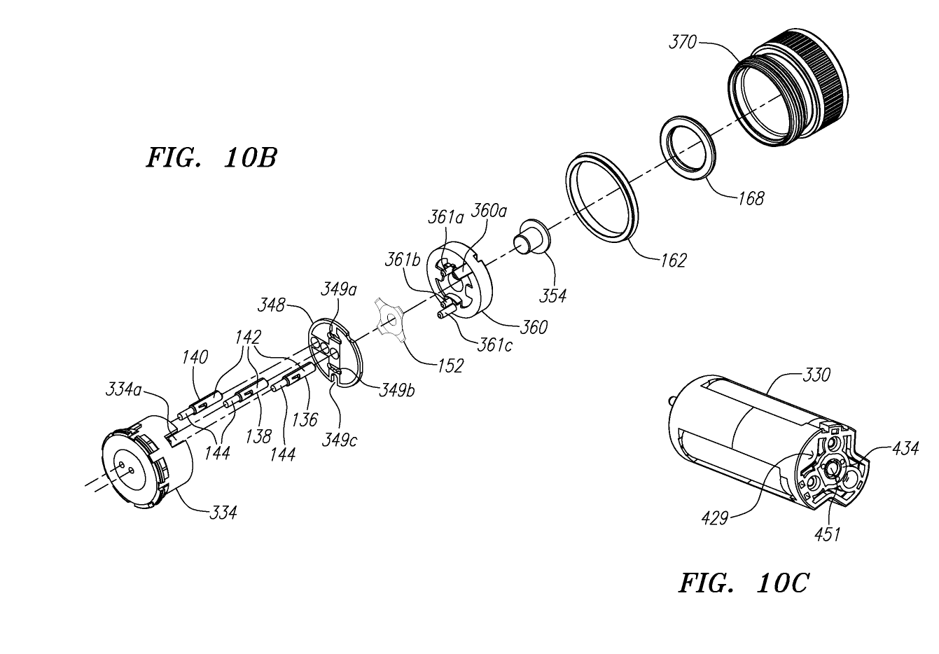

FIG. 10A is an exploded perspective view of head assembly 104, barrel 324, lamp module 128, and battery cassette 330 of flashlight 300 of FIG. 6. Referring to FIGS. 8 and 10A, head assembly 104 may generally include combined head and face cap 112, lens 116 and reflector 118. Head assembly 104 and components including combined head and face cap 112, lens 116, reflector 118, shoulder ring 126, lamp module 128, o-rings 114, and lip seal 122 have been fully described in connection with FIGS. 3 and 5A.

Other configurations of the head assembly 104 may also be used. For example, in other embodiments, head assembly 104 may form a part of a mechanical switch means to provide a user interface.

Referring to FIG. 8, lamp module 128 is electrically coupled to flashlight 300 as follows. Flashlight 300 of the present embodiment includes a battery cassette 330 that includes positive electrode 454 which is electrically coupled to compressible positive contact 133 of lamp module 128. After the current passes through the light source, a ground connection extends from the negative electrode of the light source through heat sink housing 188, which acts as the negative contact of lamp module 128, and shoulder ring 126, which in turn is electrically coupled to a connector pin 424 of battery cassette 330. The ground path continues to the conductive ring 335 of lower switch housing 334 (best shown in FIG. 9), to spring probe assembly 140, and to circuit board 348 which includes a negative contact that is coupled to a negative electrode on battery cassette 330 thereby completing the circuit.

FIG. 9 is an enlarged partial cross-sectional view of a rearward section of flashlight 300 of FIG. 6 taken through the plane indicated by line 302-302. (In FIG. 9, however, battery cassette 330 is not shown in cross-section.) The rearward section of flashlight 300 generally comprises switch and tail cap assembly 306 as reflected in FIGS. 6 and 7. FIG. 10B is an exploded perspective view of switch and tail cap assembly 306.

Referring to FIGS. 9 and 10B, switch and tail cap assembly 306 of the present embodiment preferably includes lower switch housing 334, spring probe assemblies 136, 138, 140, circuit board 348, snap dome 152, actuator 354, upper switch housing 360, sealing element 162, such as a one-way valve, switch port seal 168, and tail cap 370. Spring probe assemblies 136, 138, 140 have been fully described in connection with FIGS. 4 and 5B.

Lower switch housing 334 preferably includes three cylindrical channels 393 opened to the forward end of lower switch housing 334 for receiving and holding at least a portion of the plunger 144 of each spring probe assemblies 136, 138, 140. Each of the channels 393 is connected to a cylindrical chamber 395 which is axially aligned with the channel 393. The diameter of each cylindrical chamber 395 is larger than the channel diameter so that each chamber may receive and house the barrel 142 of each spring probe assemblies 136, 138, 140. In the present embodiment, lower switch housing 334 preferably comprises a non-conductive material, such as plastic, but other suitable materials or materials systems may also be used.

Spring probe assemblies 136, 138, 140 also push forward until their front end engage with a contact described below. The channels 393 of lower switch housing 334 and therefore, spring probe assemblies 136, 138, 140 are configured to align with contacts on the bottom of battery cassette 330. When battery cassette 330 is installed, spring probe assembly 136 may be aligned with a bottom central contact 451 of battery cassette 330, and spring probe assembly 138 may be aligned with a bottom outer contact 434 of battery cassette 330. On the other hand, spring probe assembly 140 may be aligned with a conductive ring 335 of lower switch housing 334. The conductive ring 335 may be further aligned with a rear end 429 of connector pin 424 of battery cassette 330.

In the present embodiment, lower switch housing 334 preferably comprises a non-conductive material, such as plastic, but other suitable materials may be used. Spring probe assemblies 136, 138, 140 are preferably made out of metal so as to form part of the electrical paths of flashlight 300 to be described later.

Contact ring 335 (shown in FIGS. 9 and 10B), which is preferably made out of metal, may be co-molded with lower switch housing 334 to provide an interface between the spring probe assembly 140 and the rear end 429 of connector pin 424 of battery cassette 330. Thus, a portion of the negative, or ground, path for the lamp module 128 is formed.

Circuit board 348 preferably includes contacts on both sides. Circuit board 348 may also include conductive vias routed through board 348 to couple the contacts on opposite sides. Alternatively, wires may be routed around board 348 to couple contacts on opposite sides. Circuit board 348 may also include electronic components installed thereon. In the present embodiment, the front side of circuit board 348 (which is facing the lower switch housing 334) includes three contact pads that are electrically couple to spring probe assemblies 136, 138, 140, respectively. The rear side of circuit board 348 (which is facing the upper switch housing 360) includes contact pads that correspond to SWITCH 1020 and 4.5 VDC 1014 and that are located at designated locations. Each pair of the corresponding contacts on the front side and rear side of circuit board 348 are electrically connected through conductive vias provided in circuit board 348, or alternatively routing wires. The electronic components and their function assembled on circuit board 348 will be described later in this specification.

Upper switch housing 360 includes a cylindrical channel 397 that allows actuator 354 to slide within. An annular rim of switch port seal 168 is held between an annular lip 399 of outer tail cap 370, which is located at the rear end of flashlight 300. When a user presses on switch port seal 168, actuator 354 is moved forward within channel 397 and engages snap dome 152 such that SWITCH contact pad 1020 and 4.5 VDC contact pad 1014 on the rear side of circuit board 348 are electrically coupled through snap dome 152. When the user releases switch port seal 168, the SWITCH contact pad 1020 and 4.5 VDC contact pad 1014 on the rear side of circuit board 348 are no longer electrically coupled through snap dome 152. In other embodiments, non-mechanical switches, for example, capacitors, may be used.

Upper switch housing 360 preferably includes a set of keys 361a, 361b and 361c (shown in FIG. 10B). These keys 361a, 361b and 361c are intended to be plugged into slots 349a, 349b and 349c, respectively, on circuit board 348 to align the upper switch housing 360 and circuit board 348 in a desired relative position. The configuration of a short key 361a on one side while a short key 361b and a long key 361c on the other side creates a polarized keying feature.

In the present embodiment, as best seen in FIG. 10B, upper switch housing 360 preferably includes an alignment feature 360a projecting forward and received within a mating recess 334a on lower switch housing 334. These mating features 360a, 334a may be used during assembly to help align keys 361a, 361b, 361c with their slots 349a, 349b, 349c formed in circuit board 348 and mating holes (not shown) formed in the bottom of lower switch housing 334. The mating holes formed in the bottom of the lower switch housing 334 are preferably dimensioned to receive their respective key so as to form an interference fit. In other embodiments, a male alignment feature may be provided on the lower switch housing 334 and a corresponding female feature may be provided on the upper switch housing 360.

In the present embodiment, upper switch housing 360 and actuator 354 preferably comprise a non-conductive material, such as plastic. Switch port seal 168 also preferably comprises a flexible non-conductive material, such as rubber. Snap dome 152 preferably comprises a conductive material such as metal. Other suitable materials may be used.

A one-way valve, such as a lip seal 162, may be provided at the interface between barrel 324 and the switch and tail cap assembly 306 to provide a watertight seal while simultaneously allowing overpressure within the flashlight to expel or vent to atmosphere. However, other forms of sealing elements, such as an o-ring, may be used instead of lip seal 162 to form a watertight seal. Lip seal 162 is preferably made out of non-conductive material, such as rubber.

Tail cap 370 preferably includes threads 331 (shown in FIGS. 9 and 11A) on the front outer surface of tail cap 370 for mating with threads 329 on the rear inner surface of barrel 324.

Other configurations of switch and tail cap assembly 306 may be used. For example, the switch function may be included in a side, push button switch or in an internal rotating head assembly switch such as that employed in U.S. patent application Ser. No. 12/353,396, filed Jan. 14, 2009.

Referring now to FIGS. 8, 9 and 10A, battery cassette 330 preferably contains batteries used to power the flashlight 300 or other lighting device. After the batteries are inserted into battery cassette 330, it may be inserted into flashlight barrel 324 along with other components of flashlight 300. In the present embodiment, a center connector 450 is used to provide positive contact at both ends of battery cassette 330, i.e., the positive contact at its top end 454 and the positive contact at its bottom central contact 451. In the present embodiment, a spring probe 424 is used to provide negative contact at both ends of battery cassette 330, i.e., the negative contact at its top end 423 and the negative contact at its bottom 429.

Battery cassette 330 included in the exemplary flashlight 300 is described in detail in co-pending U.S. Provisional Patent Application Ser. Nos. 61/145,120, filed Jan. 16, 2009, by Stacey West et al., the contents of which were incorporated by reference above.

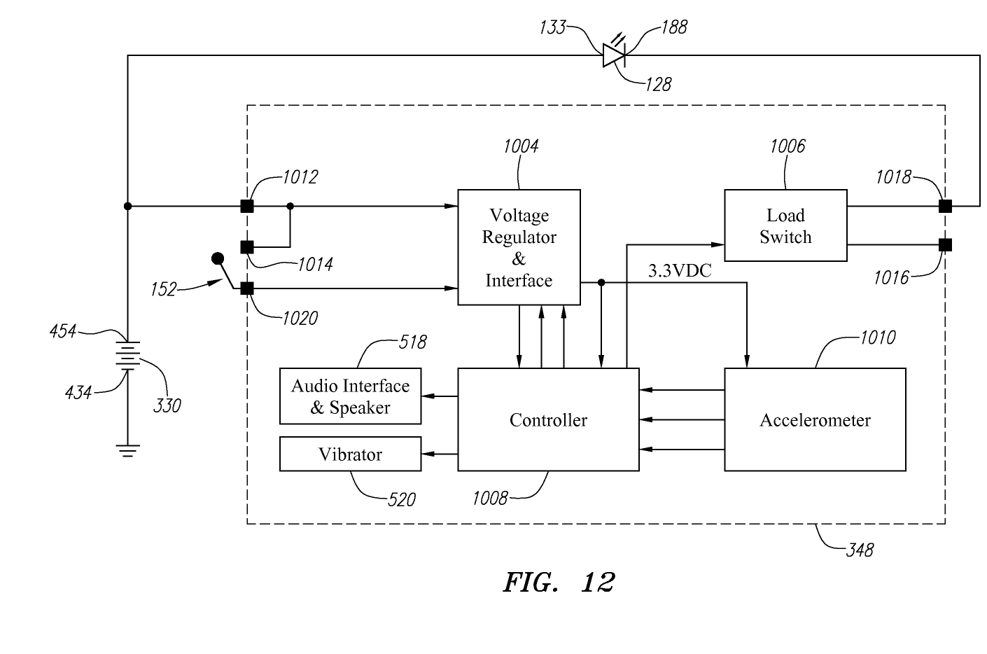

Referring also to FIG. 12, when battery cassette 330 is installed into battery compartment 327, in the present embodiment, an electrical path for the light source (or electrical load) may be formed from the central electrode or forward end 454 of battery cassette 330 to the compressible positive contact 133 of lamp module 128, and through the light source 101. the electric path continues from the light source 101 to heat sink 188 of lamp module 128, to conductor pin 424 of battery cassette 330, contact ring 335 of lower switch housing 334, spring probe assembly 140, a load switch 1006 on circuit board 348, ground pad on the front side of circuit board 348, spring probe assembly 138, and finally to the negative electrode 434 of battery cassette 330.

The functions and electrical circuit supporting the functions for flashlight 300 will be described hereafter. It would be understood that the functions and electrical circuit supporting the functions for flashlight 300 can also be used for flashlight 100.

In the present embodiment, flashlight 300 includes five predefined functional modes: a dim light with a variable brightness (DIM), a blinking light with a variable blinking frequency (STROBE), a SOS mode with variable brightness (SOS), a motion sensitive signal mode (SIGNAL), and a night light mode (NITE LITE). It is understandable that the modes presented in the present embodiment can be removed and/or other modes can be added to make a flashlight with desirable functions. In this paper, blink and strobe are interchangeably used. Also, night light and NITE LITE are interchangeably used.

The rear end of the tail cap 370 preferably has a plurality of icons 180 to be used as indications for functional mode selection. As the example shown in FIG. 11B, tail cap 370 has five mode associated icons 370a, 370b, 370c, 370d and 370e evenly spaced around the rear circumference 371 of tail cap 370. The icon associated with the DIM mode 370a is positioned at the 12:00 o'clock direction, the icon associated with the STROBE mode 370b is positioned between the 12:00 o'clock and 3:00 o'clock direction, the icon associated with the SOS mode 370c is positioned between the 3:00 o'clock and 6:00 o'clock direction, the icon associated with the SIGNAL mode 370d is positioned between the 6:00 o'clock and 9:00 o'clock direction, and the icon associated with the NITE LITE mode 370e is positioned between the 9:00 o'clock and 12:00 o'clock direction. The separation between each pair of adjacent icons is, therefore, 360° divided by 5 which is 72°. In other embodiments, icons 370a, 370b, 370c, 370d and 370e do not need to be evenly spaced around the rear circumference 371 of tail cap 370.

Flashlight 300 may be turned on by pressing the momentary switch for a predetermined period of time while the flashlight is in horizontal position to cause it to enter a new mode of operation. The new mode of operation is determined by the position of the flashlight. In other words, the new mode of operation is determined by the icons which is facing at a predefined position. In the present embodiment, the mode associated with a specific icon 180 facing at the 12:00 o'clock direction is selected as the new mode the flashlight 300 enters. This interface with mode associated icons 180 simplifies the mode selection procedure for the user. Any mode can be immediately selected without having to perform a sequence of operations.

In the present embodiment, icons 180 are laser engraved to provide high contrast for easily seen, even in poor lighting conditions. Other means for displaying icons 180 can also be used. For example, icons 180 can be painted, labeled, laminated, silkscreening, stamping, pad printing, mechanically engraving, or heat transfer/dye sublimation.

In addition, icons 180 can be illuminated, for example, by phosphor ink, or other technique such as backlighting, to make icons 180 glow in the dark. As a result, icons 180 can be visible in darkness.

Icons 180 can be applied to flashlight 300 after switch and tailcap assembly 306 is assembled. If this is the case, the tips of spring probe assemblies 136, 138, 140 can be used as indexing for orientation while icons 180 are applied.

In other embodiments, icons 180 can be placed other than the rear circumference 371 of tail cap 370. For example, icons 180 can be placed on the middle outer circumference of tail cap 370.

In other embodiments, more or less than five icons can be used depending on the number of functional modes desired.

Because icons 180 are engraved on the rear circumference 371 of tail cap 370, in the present embodiment, a keying feature between the upper switch housing 360 and circuit board 348 is used to hold the orientation of the circuit board 348 to the laser engraved icons 180.

Alternatively, if keying feature is not used, a calibration routine can be performed to align the icons to circuit board 348. If this is the case, the calibration can be performed during manufacturing. If unintended rotation occurs after manufacturing, a procedure can be performed by circuit board 348 to re-align the icons with the circuit board 348.

FIG. 12 is a block diagram illustrating an electric circuit for flashlight 300. The electric circuit includes a power source 330, a light source 128, and a circuit board 348. The circuit board 348 may include voltage regulator circuit and interface 1004, load switch circuit 1006, controller circuit 1008, and accelerometer circuit 1010.

Circuit board 348 may also include audio interface & speaker 518 and vibrator 520. This may be desirable, for example, where an audible or tactile response is desired in response to the entry of a command, such as selection of one or more modes as described below. Instead of locating the audio interface & speaker 518 and vibrator 520 on circuit board 348, one or both of them may be located off board. In other words, audio interface & speaker 518 and/or vibrator 520 is not required to be mounted on circuit board 348 but may be included elsewhere within flashlight 300.

The circuit board 348 may include I/O pads to engage external devices. I/O pads may include top +4.5 VDC 1012, bottom +4.5 VDC 1014, GND 1016, LED_OUT 1018 and SWITCH 1020.

Referring also to FIG. 10C. the I/O pads top +4.5 VDC 1012 and GND 1016 may be coupled to the central contact 451 and the outer contact 434 of battery cassette 330, respectively. I/O pads bottom +4.5 VDC 1014 and SWITCH 1020 may be coupled to snap dome 152. When a user presses on switch port seal 168, actuator 354 may be pushed forward to engage snap dome 152 to close the switch between SWITCH 1020 and +4.5 VDC 1014. When the user releases switch port seal 168, the switch is open and SWITCH 1020 is no longer coupled to +4.5 VDC 1014.

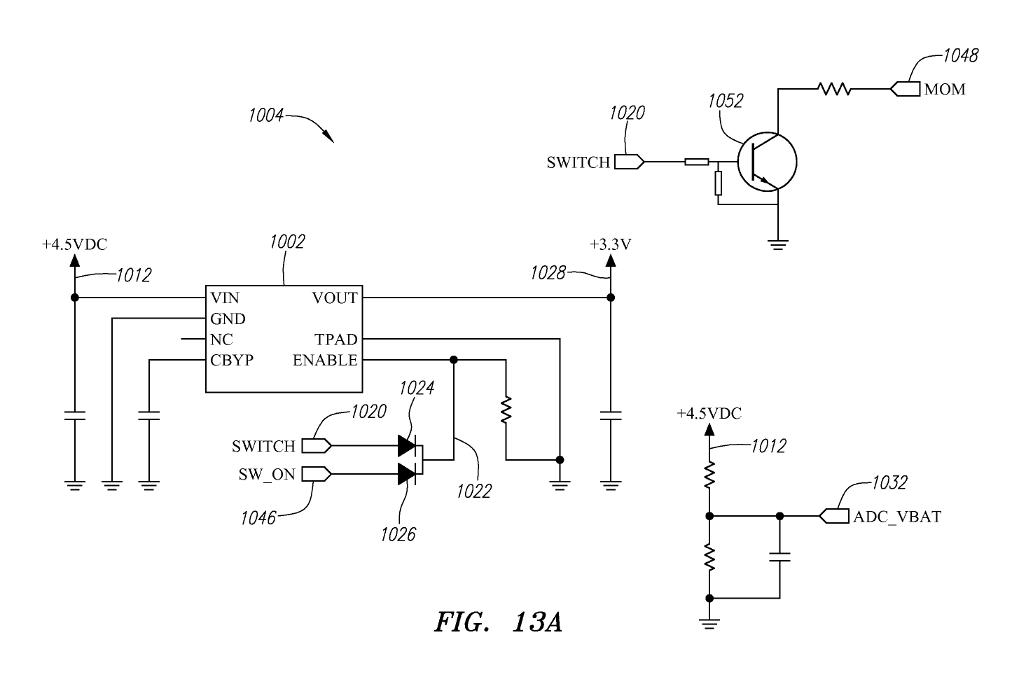

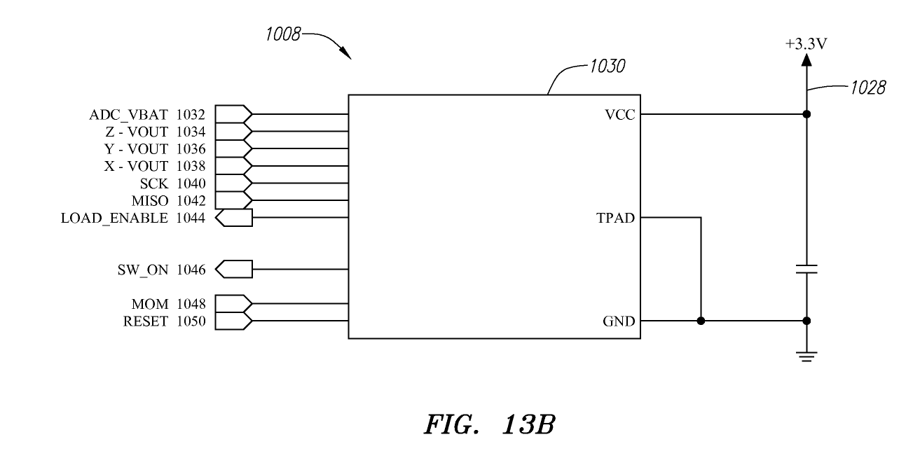

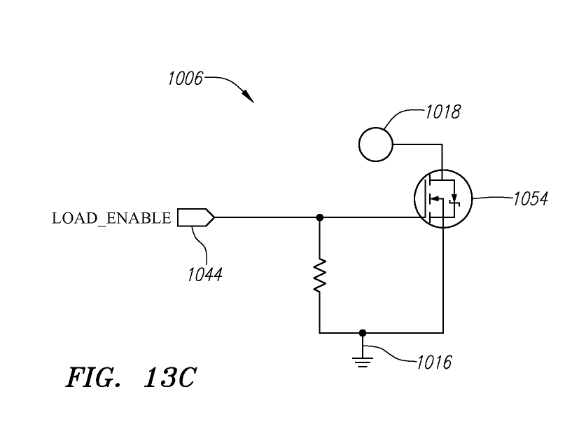

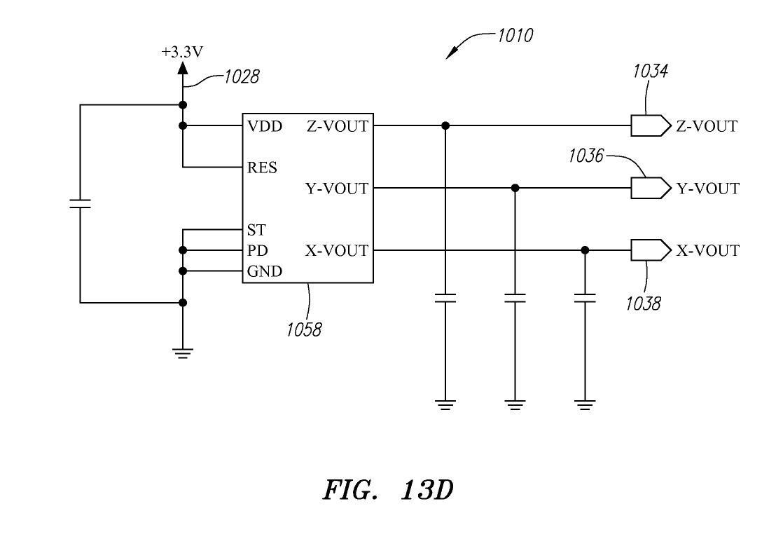

Detailed electrical circuit schematics of an embodiment of circuit board 348 are shown in FIGS. 13A-D.

FIG. 13A shows a circuit schematic diagram of a preferred voltage regulator circuit 1004. Voltage regulator circuit 1004 may include a low dropout regulator 1002, which may be implemented by a DC linear voltage regulator operated with a small input-output differential voltage. Signal line 1022 is an output from two diodes 1024, 1026 which may be driven by signal lines SWITCH 1020 and SW_ON 1046, respectively. This configuration preferably allows the higher voltage from signal lines SWITCH 1020 or SW_ON 1046 to enable low dropout regulator 1002.

In a preferred embodiment, the output of low dropout regulator 1002 may be set to +3.3V 1028 for use as a power supply source to other components, for example, controller circuit 1008. In one embodiment, a commercial stand-alone LDO regulator, e.g., ISL9003AIRUNZ manufactured by Intersil Corporation, may be used. It should be understood that other types of linear regulator circuits may also be employed.

The voltage supply level from battery (i.e. +4.5 VDC 1012) may be monitored by controller circuit 1008 through signal line ADC_VBAT 1032. Signal line ADC_VBAT 1032 may be generated by a voltage divider from +4.5 VDC 1012.

The I/O pad SWITCH 1020 may be used to generate signal MOM 1048 for sending to controller circuit 1008 as an indication that a user is pressing on switch port seal 168 when MOM 1048 is low. MOM 1048 may be generated by NPN bipolar transistor 1052.

FIG. 13B is a circuit schematic diagram of a preferred controller circuit 1008. Controller circuit 1008 may include controller 1030 with input and output connections. Controller 1030 may receive input signals through signal lines ADC_VBAT 1032, Z-VOUT 1034, Y-VOUT 1036, X-VOUT 1038, SCK 1040, MISO 1042, MOM 1048 and RESET 1050. Controller 1030 may also deliver output signals through signal lines LOAD_ENABLE 1044 and SW_ON 1046. The power supply of controller 1030 may be supported by the +3.3V 1028 power supply.

In one embodiment, controller 1030 is a commercially available controller having embedded memory, e.g., an ATtiny24 which is an 8-bit controller manufactured by Atmel Corporation. In another embodiment, controller 1030 may be a microprocessor. Yet in other embodiments, controller 1030 may be discrete circuits. Those skilled in the art will appreciate that other types of controller circuits may also be employed.

FIG. 13C shows a circuit schematic diagram of a preferred load switch circuit 1006. In the embodiment of FIG. 19B, the load switch may be implemented by NMOS 1054. The source of PMOS 1054 may be coupled to top GND 1016 while the drain of NMOS 1054 may be coupled to LED_OUT 1018. The gate of NMOS 1054 may be coupled to LOAD_ENABLE 1044. Electric power may flow from LED_OUT 1018 to GND 1016 to form a portion of a loop of electrical current that may turn on lamp module 128.

Those skilled in the art will appreciate that other types of driver and load switch circuits can also be employed.

FIG. 13D shows a circuit schematic diagram of a preferred accelerometer circuit 1010. Accelerometer circuit 1010 may include outputs Z-VOUT 1034, Y-VOUT 1036 and X-VOUT 1038 that may also be coupled to the controller circuit 1008 for further processing.

Accelerometer circuit 1010 preferably includes an inertial sensor 1058 that may receive information from its internal sensing elements and that may provide analog signals according to the measurements from the internal sensing elements. Inertial sensor 1058 may be used to measure the Earth's static gravity field by providing acceleration information in three axes, e.g., mutually orthogonal axes, namely X, Y and Z. The power supply VDD of 3-axis accelerometer circuit 1010 may be supported by the +3.3V 1028 power supply.

If the Z axis of inertial sensor 1058 is pointing towards the center of the Earth, then X and Y will have an acceleration of zero. Z, however, will experience an acceleration of −1 G due to the gravity of the Earth. If inertial sensor 640 was flipped 180° so that Z is pointing away from the Earth, X and Y will remain at zero, but Z will have an acceleration of +1 G.

Inertial sensor 1058 may be attached to circuit board 348 so that the X, Y and Z axes are fixed relative to flashlight 300. In a preferred embodiment, inertial sensor 1058 is oriented on board 348 so that the Z axis extends along the longitudinal axis of flashlight 300. As such, when flashlight 300 is positioned horizontally, the Z axis also extends horizontally. In this position, when flashlight 300 rotated left or right about the longitudinal axis of the flashlight 300 to a different orientation, as the magnitudes of the acceleration in the X and Y axes change during rotation, gravity information on X and Y may be sent to controller 1030 through X-VOUT 1038 and Y-VOUT 1036, respectively to determine the orientation of flashlight 300. In other words, the orientation of flashlight 300 can be determined.

Relative angular rotation of flashlight 300 may also be detected. When flashlight 300 is positioned horizontally, the Z axis also extends horizontally. In this position, when X and Y are rotated left or right about the longitudinal axis of the flashlight 300, as the magnitudes of the acceleration in the X and Y axes change during rotation, gravity information on X and Y may be sent to controller 1030 through X-VOUT 1038 and Y-VOUT 1036, respectively. Relative angular rotation may be computed by controller 1030. Controller 1030 may use the information on X-VOUT 1038 and Y-VOUT 1036 to determine whether there is a rotation about the longitudinal axis of flashlight 300.

In a preferred embodiment, the switch for flashlight may be located in switch and tail cap assembly 106. In this arrangement, the starting orientation of the X and Y axes are unknown, so a starting may be calculated based on the Earth's gravitational field in the X and Y axes in the starting orientation. Once their starting orientation is established, subsequent angular measurements may be made to track the rotation of flashlight 300.

It is preferred that flashlight 300 be positioned approximately horizontally for the user to obtain higher resolution when rotating, i.e., better sensing of the rotation of the X and Y axes. As the Z axis tilts farther from horizontal, rotational errors may occur. In operation, it is preferred that flashlight 300 be held to an angle from horizontal. If the tilting is greater than 30°, it is preferred that the Z axis be monitored and the rotational input ignored until flashlight 300 is tilted back within the +/−30° window. The above angles, however, may be decreased or increased in different implementations.

In a preferred embodiment, inertial sensor 1058 may be a commercially available micro-electro-mechanical systems (MEMS), e.g., LIS394AL which is a 3-axis accelerometer manufactured by ST Microelectronics. Those skilled in the art will appreciate that other types of inertial sensor circuits may also be employed.

The variable brightness on lamp module 128 may be determined by changing the duty cycle on lamp module 128 with a frequency that is higher than a human's eye can detect. A duty cycle on lamp module 128 may be produced by a sequence of high and low states on the output of load switch circuit 1006, which can be driven by controller 1008 together with other components. If the time period of conductive is longer, lamp module 128 is brighter. On the other hand, if the time period of conductive is shorter, lamp module 128 is dimmer.

The variable blinking rate on lamp module 128 can also be determined by changing the duty cycle on lamp module 128 but with a frequency that is detectable by a human's eye. The circuits that supports the variable blinking rate can be the same as that supports variable brightness described previously.

As a combination, the SOS mode with variable brightness or a blinking lighting with variable brightness on lamp module 128 may be produced by making a duty cycle on lamp module 128 with a frequency that is detectable by a human's eye. During the low cycle, lamp module 128 is off while during the high cycle, lamp module 128 can have a duty cycle with a frequency that is higher than a human's eye can detect. In other words, there is a high frequency duty cycle within the high period of a low frequency duty cycle. This function can be performed by controller 1008.

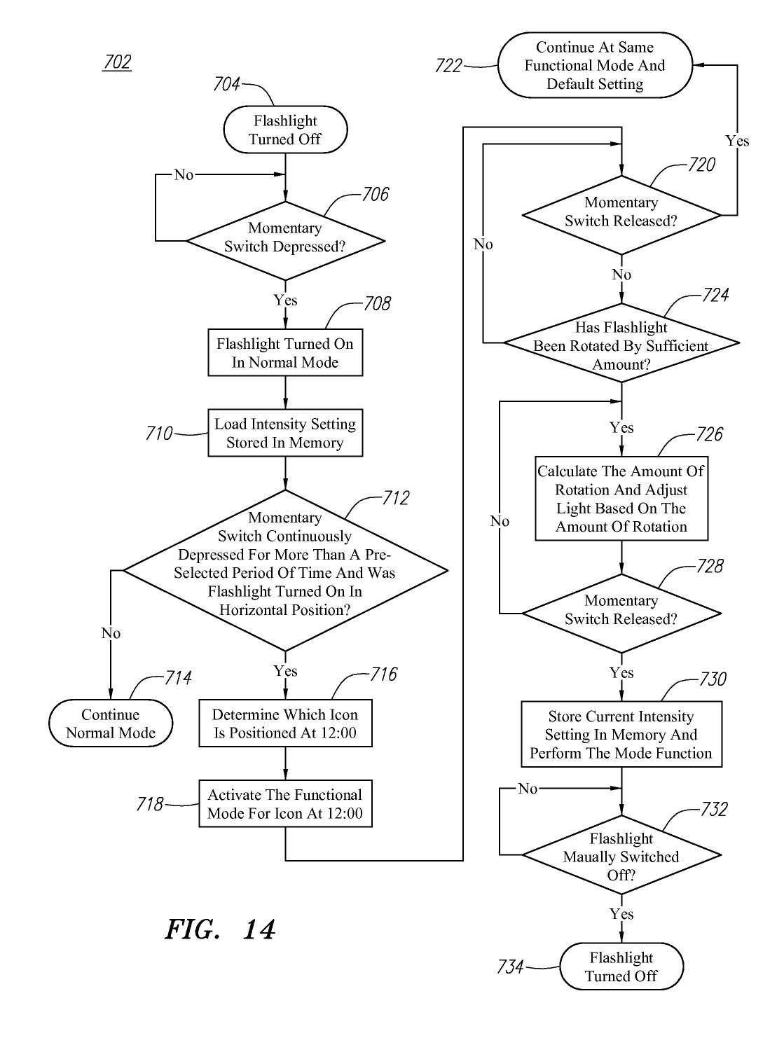

As indicated above, it is preferred that flashlight 300 may operate in multiple modes. The operation and accessing of these modes are now further discussed. FIG. 14 is a flow diagram illustrating a preferred manner of operation 702 in which flashlight 300 may access and perform various modes.

When flashlight 300 is turned off 704, circuit board 348 can still be powered by the battery cassette 330. Therefore, flashlight 300 continuously monitors the position and motion of the flashlight 300 while detecting the position of momentary switch 168. If switch 168 is depressed 706, flashlight 300 is turned on in normal mode 708.

When flashlight 300 is turned on in normal mode 708, a default intensity information may be loaded from a memory 710 for controller 1008 to provide a control signal to control the brightness on lamp module 128. In a preferred embodiment, the memory may be an EEPROM embedded in controller 1008. The default intensity information can be the intensity of the last usage before flashlight 300 is turned off. Alternatively, the default intensity information may be a predetermined setting, for example, the maximum intensity. Other intensities may be predetermined.

After the default intensity information is loaded from memory 710, if flashlight 300 is not held in horizontal position when turned on or if switch 168 is not continuously depressed for more than a predetermined period of time 712, flashlight 300 continues in normal mode 714. In one embodiment, the predetermined period of time is one second. It is understandable that other time periods can be used. At this stage, flashlight 300 is working as a normal flashlight with a steady brightness and can be turned off when the switch 168 is depressed a second time.

On the other hand, if flashlight 300 is held in horizontal position when turned on while switch 168 is continuously depressed for more than a predetermined period of time 712, flashlight 300 can enter into a new mode of operation.

The new mode of operation can be designated as one of the following examples: a dim light with a variable brightness (DIM), a blinking light with a variable blinking frequency (STROBE), an SOS mode with variable brightness (SOS), a motion sensitive signal mode (SIGNAL), or a night light mode (NITE LITE). The new mode of operation is determined by the icon associated with the new mode. If a specific icon is facing up, or the 12:00 o'clock direction, while switch 168 is continuously depressed for more than a predetermined period of time 712 and flashlight 300 is held in horizontal position when turned on, the mode associated with the specific icon is selected 716.

For example, if the DIM icon 370a is facing up as shown in FIG. 11B, then after step 716, DIM functional mode is selected. On the other hand, for example, if the SOS icon 370c is facing up, then after step 716, SOS functional mode is selected. This interface simplifies the mode selection procedure for a user. Any mode can be directly selected by facing the desired mode associated icon to a predefined position so that guessing or remembering a sequence of operations is not required by a user.

When flashlight 300 enter a new functional mode 718, a default intensity information may be loaded from a memory 710 for controller 1008 to provide a control signal to control the brightness on lamp module 128. The default intensity information can be the intensity of the last usage before flashlight 300 is turned off. Alternatively, the default intensity information may be a predetermined setting, for example, the maximum intensity. Other intensities may be predetermined.

In the present embodiment, when the current mode is DIM mode, STROBE mode, SOS mode and SIGNAL mode, the intensity of the last usage before flashlight 300 is turned off is used as the default intensity. On the other hand, if the current mode is NITE LITE mode, the maximum intensity is used as the default intensity.

At this moment, if switch 168 is released 720, flashlight 300 will continue at the current functional mode with default intensity setting 722 until flashlight 300 is turned off by a designated method. For example, if switch 168 is depressed and then released, flashlight 300 may recognize this sequence as a switch off command and flashlight 300 will be turned off

If flashlight 300 is rotated left or right 724 about its principal axis of projection 310 while switch 168 is still continuously depressed 720, the amount of rotation can be calculated by controller 1008 and an adjustment is performed 726. If the current mode of operation is DIM mode, for example, the brightness of flashlight 300 may be varied based on the calculated amount of rotation 726. On the other hand, if the current mode of operation is STROBE mode, then, the frequency of duty cycle may be varied based on the calculated amount of rotation 726.

In a preferred embodiment, before the flashlight 300 is rotated, the flashlight brightness is set to the intensity information stored in memory. When the flashlight 300 is rotated left or right 10°, the flashlight brightness is set to the maximum if the current mode of operation is the DIM mode, the SOS mode, or the SIGNAL mode. While when the flashlight 300 is rotated left or right 45° and beyond, the flashlight brightness is set to the minimum. In other words, when the flashlight 300 is rotated left or right from 10° to 45°, the flashlight brightness can change linearly from maximum to minimum.

If the current mode of operation is the STROBE mode, when flashlight 300 is rotated left or right 10°, the flashlight frequency is set to the maximum. While when the flashlight 300 is rotated left or right 45° and beyond, the flashlight frequency is set to the minimum. In other words, when the flashlight 300 is rotated left or right from 10° to 45°, the flashlight frequency can change linearly from maximum to minimum.

Since mode selection is based on icon position at startup, rotating the barrel along the principle axis of projection of flashlight 300 is used only for mode adjustments. Therefore, the adjustments can be performed by either left rotation or right rotation. The adjustments to the modes are symmetrical and mirrored across a virtual vertical plane that runs longitudinally through the principal axis of projection 310 of flashlight 300, therefore, this feature helps the users with either left-handed or righted-hand preference.

In the present embodiment, the maximum brightness is performed by providing a pulse current with 100% duty cycle to the lamp module 128 and the minimum brightness has a duty cycle of 5%.

If a suitable brightness (for DIM, SOS, or SIGNAL modes) or frequency (for STROBE mode) is found while flashlight 300 is rotating left or right 724, the switch 168 may be released 728 and the brightness or frequency existing at that time may be stored in a memory and perform the selected mode function 730. Flashlight 300 may retain that level of brightness or frequency until a new setting is stored next time.

On the other hand, if switch 168 is released 728 and the current mode is SIGNAL mode, the motion sensitive signal operation may be performed 730 by detecting whether there is a left or right rotation along the principal axis of projection 310 of flashlight 300. If a rotation is detected, then flashlight 300 can be turned on. If the flashlight 300 is turned back to the previous position, then flashlight 300 can be turned off. In other words, flashlight 300 can be toggled between on and off by rotating it left or right and then rotating it back.

Flashlight 300 may be turned off 734 by a designated method. For example, if switch 168 is depressed and then released, flashlight 300 may recognize this sequence as a switch off command 732 and flashlight 300 will be turned off 734.

Those skilled in the art will appreciate that the flow diagram 702 illustrated in FIG. 14 is an example, and that other types of operations may also be employed.

The operation flow 702 shown in FIG. 14 can be implemented by software stored in a memory of controller 1008. Thus, controller 1008 can be programmed to control the sequence of operation based on signals received from the outputs of 3-axis accelerometer circuit 1010. When controller 1008 receives information from outputs X-VOUT 1038 and Y-VOUT 1036 of the accelerometer circuit 1010, controller 1008 may change its sequence of execution based on such information.

Controller 1008 may also be programmed to control the flow of electrical power through lamp module 128 based on signals received from the outputs of accelerometer circuit 1010. When controller 1008 receives information from X-VOUT 1038 and Y-VOUT 1036, controller 1008 may change some of its output signals based on the execution of software stored in the controller 1008.

Other types of movements of flashlight 300 that may cause a change in the outputs of the accelerometer circuit 1010 may also be used as a command for flashlight 300 to change features. Accordingly, the current invention is not limited to the movements described herein for interfacing with controller 1008.

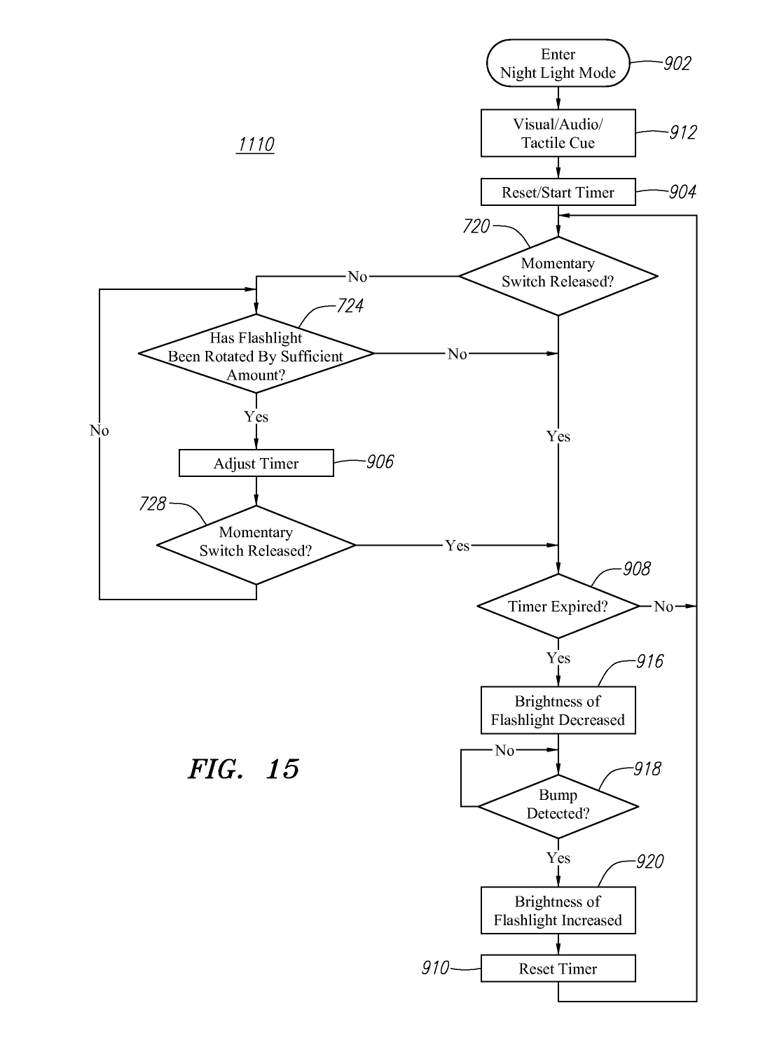

FIG. 15 is a flow diagram illustrating a method 1110 for operating flashlight 300 in a night light mode of operation. The method 1110 shown in FIG. 15 for operating flashlight 300 in a night light mode of operation is shown in more detail than that provided in FIG. 14. Step 902 thus corresponds to step 718 in FIG. 14 when the night light mode is selected. When flashlight 300 enters the night light mode in step 902, the controller 1008 is preferably configured so that the light source of flashlight 300 initially provides light at a constant brightness.

After flashlight 300 enters the night light mode in step 902, in step 912 the controller 1008 may be programmed to output a command to load switch 1006, audio interface & speaker 518, and/or vibrator 520 to provide a visual, audio, and/or tactile cue that the night light mode has been selected and entered. This cue provided in step 912 is beneficial because, in the absence of such a cue in the present embodiment, there would be no immediate operational change in the brightness of the light source before the timer is expired at step 908. Thus, providing a visual, audio, or tactile cue in step 912 will inform the user of the selection of the night light mode and make the use of the flashlight 300 more user friendly.

The visual cue may be a simple flash of the light off and then back on. Alternatively, it could be a series of two or more flashes. To provide an audio cue in step 912, either in addition to the visual cue or in the alternative, the controller 1008 may be programmed to output a certain sequence of beeps or provide beeps of different tones through the audio interface & speaker 518 (see FIG. 12), which is in communication with controller 1008. A tactile cue on the other hand may be provided through the vibrator 520 (see FIG. 12), which is in communication with controller 1008.

Once the visual audio or tactile cue is performed in step 912, a timer may be reset and started in step 904. The timer is used to determine the period of time before the flashlight begins to dim. Preferably each time a bump of a predefined magnitude is sensed by controller 1008 based on one or more inputs from accelerometer 1010, the timer is reset, so that the timer is only allowed to expire, and the brightness of the light source 101 dim, if the flashlight 300 remains still for a predefined default period of time, such as 15 or 30 seconds, after the night light mode is entered in step 902. Thus, as long as the flashlight continues to be moved around with sufficient force to cause a requisite change in acceleration, the flashlight 300 will not dim.

In certain embodiments, it may be desirable to allow a user to add additional time to the timer, thereby extending the amount of time required to pass in step 908 without the controller 1008 sensing an acceleration of sufficient magnitude to dim the brightness of the light source 101 in step 916. In the embodiment shown in FIG. 12, controller 1008 is programmed to permit the user to adjust the timer. In the illustrated embodiment, the user can adjust the timer if he or she does not release the momentary switch once the night light mode is entered in step 902. On the other hand, once the user releases the momentary switch, he or she can no longer adjust the timer.

In a preferred embodiment, the timer is set initially to expire in a period of 30 seconds in step 904. If the momentary switch 168 is released any time after entering the night light mode without adjusting the timer, then controller 1008 will simply wait for the timer to expire after the default period of time lapses in step 908 before dimming the brightness of the light source 101 in step 916. However, as noted above, preferably the timer is reset each time controller 1008 senses that flashlight 300 is moved with sufficient force. it goes to step 908 to let timer expired.

On the other hand, if the controller determines in step 720 that the momentary switch 168 has not been released, then the user can adjust the default period of time of the timer, thereby delaying the time period that must lapse without movement before the brightness of the light source 101 is dimmed in step 916. For example, in the illustrated embodiment, if in step 724 the controller 1008 determines that the flashlight 300 has been rotated left or right about its principal axis of projection 310 while momentary switch 168 has been continuously depressed, the amount of rotation can be calculated by controller 1008 and the timer 906 adjusted based on the amount of rotation. The timer may be incrementally increased, by for example 15 or 30 seconds, each time flashlight 300 is rotated left or right and then rotated back to center. In other words, if additional wait time is desired, steps 724, 906 can be repeated as long as it is determined that the momentary switch remains depressed in step 728.

Once the timer has been increased by the desired amount, the user may release the momentary switch. When the release of the momentary switch is detected in step 728, the timer will begin to run until it is determined in step 908 that it has expired. As before, preferably the timer is reset (now to the adjusted timer preset) each time a force of sufficient amount is detected so that the timer is permitted to expire only if the flashlight remains still (or relatively still) for the adjusted time period.

Although the timer is preferably only adjusted by a relatively small period of 15 to 30 seconds for each left or right rotation, the timer may be incrementally increased by any amount in step 906, including for example by periods of 1 minute or 5 minutes.

As an alternative to adjusting the timer in step 906 by an incremental amount for each time that that flashlight is rotated left or right, the timer adjustment performed in step 906 can also be performed based on the amount of rotation of flashlight 300. For example, the timer may be increased by 15 seconds if the flashlight is rotated by at least 15° and less than 30°, and increased by 30 seconds if the flashlight 300 is rotated left or right by 30° or more. In other implementations other times or angles may be used. For example, the timer may be increased by an extra five minutes when flashlight 300 is rotated left or right by at least 15° and less than 30° and the timer may be increased by an extra ten minutes when flashlight 300 is rotated left or right for 30° or more.

In another implementation, a visual, audio, or tactile cue is provided when the timer is increased in step 906. Preferably the cue corresponds to the amount of time added to the timer or the adjusted period of time of the timer, so that the user knows by how much the timer has been increased.

Once the timer expires in step 908, the brightness of the light source 101 of flashlight 300 may be decreased in step 916. In the present embodiment, light source 101 of flashlight 300 may be gradually dimmed until reaching its lowest brightness. In another embodiment, light source 101 of flashlight 300 may be gradually dimmed until eventually it is completely off.

Once flashlight 300 has been dimmed in step 916, it may continuously provide the lowest (or other pre-set) brightness until flashlight 300 detects a bump in step 918, at which point the brightness of flashlight 300 may be increased 920 to the brightness level stored in memory. In the present embodiment, the brightness of light source 101 of flashlight 300 is set to the brightness level that had previously been stored in memory by the user from the dim mode. In other embodiments, however, the brightness of light source 101 of flashlight 300 may simply be adjusted to its highest brightness level. Once the brightness has bee been increased in step 920, the timer is reset in step 910 to the adjusted time period if the timer was adjusted in step 906 other wise the default time period. The routine then goes back to step 720 and then to step 908 where the controller 1008 monitors whether the reset timer has expired. Again, preferably the timer is reset each time a movement of a sufficient magnitude is detected so that the brightness of the light source 101 of flashlight 300 is only dimmed if the flashlight 300 remains still or is not moved sufficiently quickly.

As previously described in connection with FIGS. 12 and 13D, accelerometer circuit 1010 has outputs that may also be coupled to controller circuit 1008. The accelerometer circuit 1010 may be mounted on circuit board 348 with its Z-axis extending along the longitudinal axis of flashlight 300. When flashlight 300 is in a horizontal position, if flashlight 300 is rotated clockwise or counter-clockwise about its longitudinal axis 310, the magnitudes of the acceleration in the X and Y axes may change, and the gravity information on X and Y may be sent to controller 1008 through X-VOUT 1038 and Y-VOUT 1036, respectively. Controller 1008 may use information from X-VOUT 1038 and Y-VOUT 1036 to determine whether there is a rotation about the longitudinal axis 310 of flashlight 300. When flashlight 300 is in a horizontal position, if flashlight 300 is tilted up about 45°, the magnitudes of the acceleration in the Z axis will change, and the gravity information on Z may be sent to controller 1008 through Z-VOUT 1034. Controller 1008 may use information from Z-VOUT 1034 to determine whether there is a tilting up of flashlight 300 and where extra wait time is required. Flashlight 300 may detect a bump or rolling (or the information change on X-VOUT 1038 and Y-VOUT 1036) and use this information to determine whether flashlight 300 should remain as a night light.

The brightness on lamp module 128 may be determined by changing the duty cycle on lamp module 128 to a frequency above which a human eye may detect. A duty cycle on lamp module 128 may be produced by a sequence of high and low states on the LOAD_ENABLE 1044 signal which is driven by controller 1008. This sequence of high and low states on signal LOAD_ENABLE 1044, together with other components on the load electrical path, may cause NMOS 1054 to be conductive and non-conductive alternately. When the percentage of conduction time in each cycle is at 100%, lamp module 128 will be at its brightest. On the other hand, as the percentage of conduction time in each cycle approaches 0%, lamp module 128 will be at its lowest brightness.

The operation flow 900 shown in FIG. 15 may be implemented by software stored in a memory of controller 1008. Controller 1008 may be programmed to control the sequence of operation based on signals received from outputs of accelerometer circuit 1010. When controller 1008 receives information from X-VOUT 1038 and Y-VOUT 1036 of the accelerometer circuit 1010, controller 1008 may change its sequence of execution based on the information.

Controller 1008 may also be programmed to control the flow of electrical power through lamp module 128 based on signals received from outputs of accelerometer circuit 1010. When controller 1008 receives information from X-VOUT 1038 and Y-VOUT 1036, controller 1008 may change some of its output signals based on the execution of software stored in controller 1008.

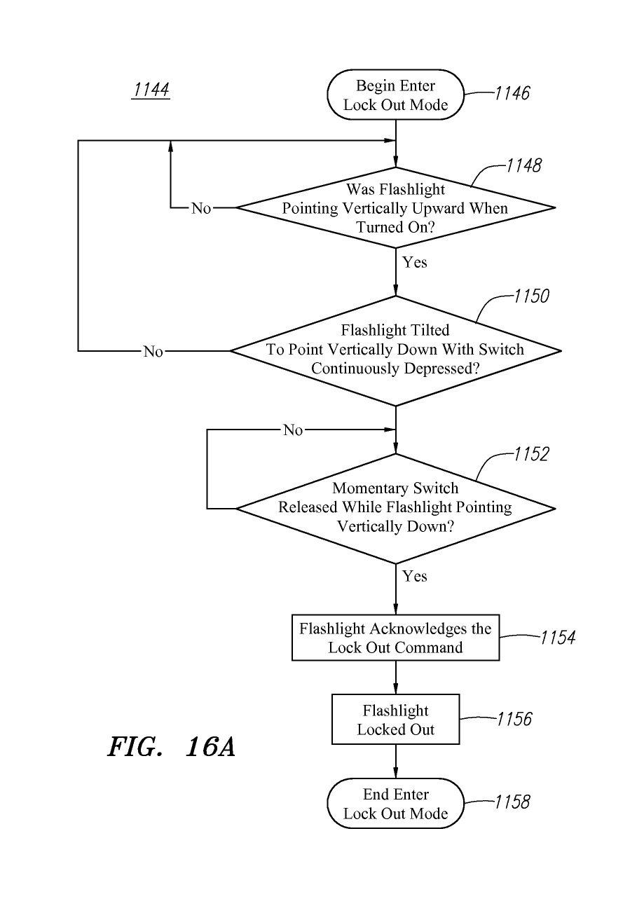

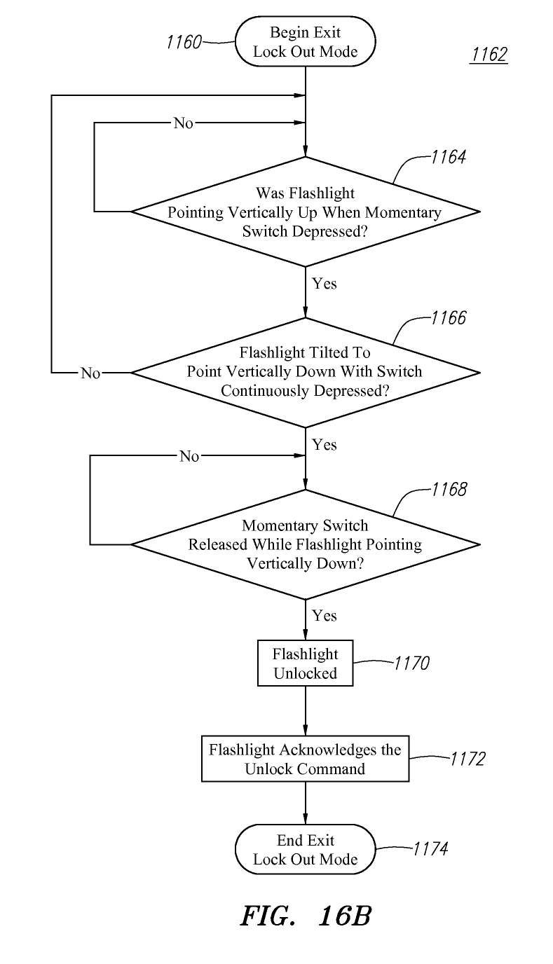

FIGS. 16A and 16B illustrate flow diagrams 1144, 1162 of a lock out feature of flashlight 300. After flashlight 300 is turned off 1146, the switch 168 might be accidentally pushed under certain conditions, such as movements of the flashlight 300 stored in a purse, a glove box, or a tool box. The accidental push on switch 168 might turn on flashlight 300 and power would lost.

The lock out feature 1144, 1162 would prevent accidental turn-on of flashlight 300 by performing a sequence of operations for flashlight 300 to enter into a lock out mode. Once flashlight 300 is in the lock out mode, all subsequent presses on switch 168 would be ignored until another sequence of operations are performed to unlock flashlight 300.

The lock out feature 1144 starts at step 1146. If flashlight 300 is not turned on 1147, and if the principal axis of projection 310 is pointed up in a substantially vertical direction followed by pointed down in a substantially vertical direction 1148 while switch 168 is continuously depressed 1150, flashlight 300 interprets the sequence as a command to lock out. Once the switch 168 is released 1152, in the present embodiment, flashlight 300 acknowledges the lock out command 1154 and enters into the lock out mode 1156. The operation of entering lock out mode 1144 is then complete 1158. While in another embodiment, once the switch 168 is released 1152, flashlight 300 may directly enter into the lock out mode 1156 without acknowledging the lock out command 1154.

In the present embodiment, flashlight 300 acknowledges the lock out command 1154 by making a blink. Alternatively, flashlight 300 may acknowledge the lock out command 1154 by providing audible or tactile responses in addition to the visual response or in the alternative.

Once flashlight 300 is locked out 1156, the only way to exit the lock out mode is through an operation of exiting lock out mode 1162. The operation 1162 starts at step 1160. If the principal axis of projection 310 is pointed up in a substantially vertical direction followed by pointed down in a substantially vertical direction 1164 while switch 168 is continuously depressed 1166, flashlight 300 interprets the sequence as a command to exit the lock out mode. Once the switch 168 is released 1168, flashlight 300 is released (or unlocked) from lock out 1170. In the present embodiment, flashlight 300 acknowledges the unlock status 1172 and that completes the exiting lock out mode operation 1162 at step 1174. In another embodiment, once flashlight 300 is released (or unlocked) from lock out 1170, the operation of exiting lock out mode 1162 is completed without performing the step of acknowledging the unlock status 1172. In one embodiment, once the operation of exiting lock out mode 1162 is completed 1174, flashlight 300 is subsequently turned on. Once flashlight 300 is locked out 1156, before flashlight 300 receives the unlock command, flashlight 300 cannot be switched on by a press and release sequence on switch 168.

In the present embodiment, flashlight 300 acknowledges the unlock command 1172 by making a blink. Alternatively, flashlight 300 may acknowledge the lock out command 1172 by providing audible or tactile responses in addition to the visual response or in the alternative.

Alternatively, other types of movements of flashlight 300 that may cause a change in outputs X-VOUT 1038 and Y-VOUT 1036 or Z-VOUT 1034 of accelerometer circuit 1010 may also be used as a command for flashlight 300 to enter or exit the lock out mode.

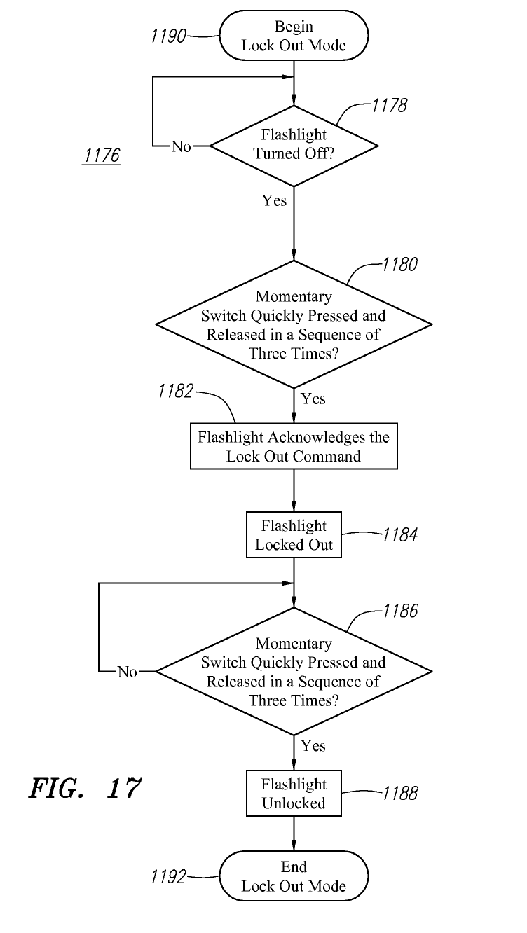

FIG. 17 is a flow diagram illustrating another lock out feature 1176 of flashlight 300. The operation starts at step 1190. If flashlight 300 is off 1178, before flashlight 300 receives the lock out command, flashlight 300 can be switched on by a switch on command such as a press and release sequence on switch 168, the light source of flashlight 300 may start producing light and the flashlight 300 may enter into a default user mode of operation.

If flashlight 300 is off 1178, and if the switch 168 is pressed and released in a sequence of three times 1180, flashlight 300 interprets the sequence as a command to lock out. In the present embodiment, flashlight 300 acknowledges the lock out command 1182 and enters into the lock out mode 1184. Alternatively, once flashlight 300 receives a lock out command, flashlight 300 may directly enter into the lock out mode 1184 without the step of acknowledgement 1182. Once flashlight 300 is locked out 1184, before flashlight 300 receives the unlock command, flashlight 300 cannot be switched on by a press and release sequence on switch 168.

When flashlight 300 is locked out 1184, if the switch 168 is pressed and released in a sequence of three times 1186, flashlight 300 interprets the sequence as a command to unlock, or release, and flashlight 300 is subsequently unlocked 1188 and exit lock out mode 1192. In one embodiment, once the operation of exiting lock out mode 1192 is completed, flashlight 300 is subsequently turned on.

In the present embodiment, flashlight 300 acknowledges the lock out command 1182 by making a blink. Alternatively, flashlight 300 may acknowledge the lock out command 1182 by providing audible or tactile responses in addition to the visual response or in the alternative.

As previously described in connection with FIG. 13D, accelerometer circuit 1010 may include outputs X-VOUT 1038, Y-VOUT 1036 and Z-VOUT 1034 that may be coupled to controller circuit 1008. Accelerometer circuit 1010 may be mounted on circuit board 348 with its Z-axis extending along the longitudinal axis of the flashlight 300. When flashlight 300 is pointed up vertically, the magnitude of the acceleration in the Z axis would be −1 G. When flashlight 300 is pointed down vertically, the magnitude of the acceleration in the Z axis would be +1 G. The gravity information on Z may be sent to controller 1008 through Z-VOUT 1034.

Controller 1008 may use the information on Z-VOUT 1034 to determine whether flashlight 300 is pointing up or down to determine whether lock out is desired.

The operation flow diagrams 1144, 1162 shown in FIGS. 16A and 16B may be implemented by software stored in the memory of controller 1008. Controller 1008 may be programmed to control the sequence of operation based on signals received from the outputs of accelerometer circuit 1010. When controller 1008 receives information from Z-VOUT 1034 of accelerometer circuit 1010, controller 1008 may change a user's preference (or parameter setting) based on this information.

A multi-mode portable electronic lighting device is contemplated. The device comprises a controller and a user interface. The controller is configured to implement a plurality of modes of operation. The user interface is configured to input commands to the controller. The user interface can have a position sensitive interface in which commands are input through at least one predefined position of the portable electronic lighting device.

A portable lighting device is contemplated. The portable lighting device is configured to operate using a portable source of power. The portable lighting device comprises a light source; a main power circuit for electrically connecting the light source to the portable source of power, the main power circuit including an electronic power switch disposed electrically in series with the light source; an inertial sensor for detecting a plurality of predetermined positions and movements of the portable lighting device; and a controller electrically coupled to the portable source of power. The controller including an output for providing a control signal for controlling the flow of power through the electronic power switch and light source in the main power circuit, wherein the controller is configured to control the flow of power through the electronic power switch based on the plurality of predetermined positions or the movements of the portable lighting device.

A method of controlling a multi-mode portable electronic lighting device is contemplated. The method comprises the steps of: determining if the portable lighting device has been positioned in one of a plurality of predetermined positions; and entering into a new mode of operation when one of the plurality of predetermined positions is detected.

While various embodiments of an improved flashlight and its respective components have been presented in the foregoing disclosure, numerous modifications, alterations, alternate embodiments, and alternate materials may be contemplated by those skilled in the art and may be utilized in accomplishing the various aspects of the present invention. For example, the power control circuit and short protection circuit described herein may be employed together in a flashlight or may be separately employed. Further, the short protection circuit may be used in rechargeable electronic devices other than flashlights. Thus, it is to be clearly understood that this description is made only by way of example and not as a limitation on the scope of the invention as claimed below.

What is claimed:

1. A multi-mode portable electronic lighting device, comprising:
a light source;
a controller controlling the operation of the light source and configured to implement a plurality of modes of operation; and
a user interface for inputting commands to the controller, wherein the user interface comprises a position sensitive interface in which commands are input through at least one predefined position of the portable electronic lighting device.

2. The multi-mode portable electronic lighting device of claim 1, wherein the user interface comprises an inertial sensor electrically coupled to the controller.

3. The multi-mode portable electronic lighting device of claim 2, wherein the inertial sensor comprises an accelerometer.

4. The multi-mode portable electronic lighting device of claim 3, wherein the accelerometer is a 3-axis accelerometer.

5. The multi-mode portable electronic lighting device of claim 1, wherein the controller is configured to receive selection commands from the user interface for selecting between different modes of operation.

6. The multi-mode portable electronic lighting device of claim 1, wherein the controller is further configured so that once at least one mode of operation is selected, the selected mode of operation may be adjusted based on an adjustment command received from the user interface.

7. The multi-mode portable electronic lighting device of claim 1, wherein the controller is configured to receive adjustment commands for adjusting one or more modes of operation once those modes of operation have been selected.

8. The multi-mode portable electronic lighting device of claim 1, wherein the controller is further configured to control a device to provide a visual, audio, and/or tactile cue when at least one of the plurality of modes has been selected.

9. The multi-mode portable electronic lighting device of claim 8, wherein the device is an electronic switch controlling the flow of current through the light source and the controller is configured to provide a visual cue.

10. The multi-mode portable electronic lighting device of claim 8, wherein the device comprises a speaker and the controller is configured to provide an audio cue.

11. The multi-mode portable electronic lighting device of claim 8, wherein the device comprises a vibrator and the controller is configured to provide a tactile cue.

12. A portable lighting device configured to operate using a portable source of power, the portable lighting device comprising:
a light source;
a main power circuit for electrically connecting the light source to the portable source of power, the main power circuit including an electronic power switch disposed electrically in series with the light source;
an inertial sensor for detecting a plurality of predetermined positions and movements of the portable lighting device; and
a controller electrically coupled to the portable source of power, the controller including an output for providing a control signal for controlling the flow of power through the electronic power switch and light source in the main power circuit, wherein the controller is configured to control the flow of power through the electronic power switch based on the plurality of predetermined positions or the movements of the portable lighting device.

13. The portable lighting device of claim 12, wherein the inertial sensor comprises an accelerometer.

14. The portable lighting device of claim 13, wherein the accelerometer is a 3-axis accelerometer.

15. The portable lighting device of claim 12, wherein the controller is configured to control the electronic power switch in a manner to provide at least two modes of operation, and wherein the controller is configured to enter into a new mode of operation when the controller determines that the portable lighting device has been positioned in one of the plurality of predetermined positions based on one or more signals received from at least one output of the inertial sensor.

16. The portable lighting device of claim 15, wherein the controller is configured to control the electronic power switch to provide a plurality of modes of operation, and wherein the controller determines that the portable lighting device has been positioned in one of the plurality of predetermined positions, wherein each one of the plurality of predetermined positions associated with one of the plurality of modes of operation.

17. The portable lighting device of claim 15, wherein the controller is configured to adjust at least one mode of operation when the controller determines that the portable lighting device has been moved in a predetermined manner.

18. The portable lighting device of claim 17 wherein one of the modes of operation comprises a variable brightness mode, and the controller is configured to vary the brightness of the light source based on the amount of movement in the predetermined manner.

19. The portable lighting device of claim 17, wherein one of the modes of operation is a visible blink mode, and the frequency of the blink is varied when the controller determines that the portable lighting device has been moved in the predetermined manner.

20. The portable lighting device of claim 17, wherein one of the modes of operation is an SOS mode, and the brightness of the light source is adjusted when the controller determines that the portable lighting device has been moved in the predetermined manner.

21. The portable lighting device of claim 15, wherein the light source is arranged to project light along a principal axis of projection when the light source is powered.

22. The portable lighting device of claim 21, wherein the portable lighting device is positioned in one of the plurality of predetermined positions when the portable lighting device is rotated about the principal axis of projection.

23. The portable lighting device of claim 22, wherein the controller is further configured so that after switching to the new mode of operation the portable lighting device must be turned off before further positioned to a second predetermined position will cause the controller to switch to another new mode of operation.

24. The portable lighting device of claim 22, wherein the plurality of predetermined positions are indicated by a plurality of icons that each one of the plurality of predetermined positions is indicated by one of the plurality of icons.

25. The portable lighting device of claim 24, wherein the plurality of icons are placed on the outer circumference of the rear end of the portable lighting device.

26. The portable lighting device of claim 24, wherein the plurality of icons are engraved by laser.

27. The portable lighting device of claim 15, wherein the controller is configured to enter into the new mode of operation only when the controller determines that the portable lighting device has been positioned in one of the plurality of predetermined positions and a mode selection feature has been enabled.

28. The portable lighting device according to claim 27, wherein the controller is configured so that the mode selection feature is enabled when a momentary switch in electrical communication with the controller is depressed and held down.

29. The portable lighting device according to claim 12, wherein the light source comprises an LED.

30. A method of controlling a multi-mode portable electronic lighting device, the method comprising:
determining if the portable lighting device has been positioned in one of a plurality of predetermined positions; and
entering into a new mode of operation when one of the plurality of predetermined positions is detected.

31. The method of claim 30, further comprising the step of determining whether a mode selection feature is enabled before switching to a new mode of operation.

32. The method of claim 31, wherein the step of determining whether a mode selection feature has been enabled comprises determining whether a momentary switch in communication with a controller of the portable lighting device was depressed when the portable lighting device was positioned in one of the plurality of predetermined positions.

33. The method of claim 31, further comprising switching to a new mode of operation each time one of the plurality of predetermined positions is detected while the mode selection feature is enabled.

34. The method of claim 33, further comprising adjusting a mode of operation when it is determined that the portable lighting device has been moved in a predetermined manner while the mode selection feature is enabled.

35. The method of claim 34, wherein one of the modes of operation comprises a variable brightness mode, and the brightness of the light source is varied during the adjusting step based on the amount of movement in the predetermined manner.

36. The method of claim 34, wherein one of the modes of operation is a signal mode, and the light source is turned off when it is determined that the portable lighting device has been moved in the predetermined manner and turned back on by moving in an opposite manner.

37. The method of claim 34, wherein one of the modes of operation is a visible blink mode, and the frequency of the blink is varied during the adjusting step based on the amount of movement in the predetermined manner.

38. The method of claim 34, wherein one of the modes of operation is an SOS mode, and the brightness of the light source is adjusted when the controller determines that the portable lighting device has been moved in the predetermined manner.

39. The method of claim 33, wherein the portable lighting device is positioned in one of the plurality of predetermined positions when the portable lighting device is rotated about a principal axis of projection.

40. A lighting device, comprising:
a housing including one or more batteries;
a light source connected to said one or more batteries;
electronic components for providing multiple modes of operation of the lighting device, and
a sensor sensing an orientation of the housing which effects one of said multiple modes of operation.

41. The lighting device of claim 40 wherein an operable switch is provided.

42. The lighting device of claim 41 wherein the switch is a tailcap switch.

43. The lighting device of claim 40, wherein the housing includes a reflector axially aligned with said light source.
